(19) United States
(12) Patent Application Publication
(10) Pub. No.: US 2026/0164491 A1
(43) Pub. Date: Jun. 11, 2026

(54) Methods and Apparatus for Measurement Based Automatic User Reconnection After an Airlink Connection Drop

(71) Applicant: Charter Communications Operating, LLC, St. Louis, MO (US)

(72) Inventor: Pareshkumar Panchal, Highlands Ranch, CO (US)

(21) Appl. No.: 18/969,852

(22) Filed: Dec. 5, 2024

(51) Int. Cl. H04W 76/19; H04W 76/14; H04W 76/30

(52) U.S. Cl. CPC H04W 76/19; H04W 76/14; H04W 76/30

(57) ABSTRACT

Methods and apparatus for automatically re-establishing a connection due to an unintentional airlink loss to one or more endpoint devices, e.g., UEs, are described. When an airlink connection between a user equipment (UE) and a base station experiences unacceptable radio network conditions, a connection drop occurs resulting in a dropped communications session. An analytics server receives a notification of the connection drop and evaluates UE measurement information, e.g., RSRP, SINR, and RSRQ, corresponding to each of the UE to base station airlinks in the endpoint device-endpoint device connection to determine when communications session re-establishment is possible. The analytics server performs successive evaluations, if an initial evaluation does not indicate that communications session re-establishment is possible. When the analytics server determines that the conditions for session re-establishment have been satisfied for each of the airlinks, the analytics server sends a re-initiation request to the core network to trigger communications session re-initiation.

### FIELD

The present invention is directed to wireless communications, and more particularly, to methods and apparatus for supporting communications session re-establishment following a dropped connection.

### BACKGROUND

In a communications network, an end user device, e.g., a user equipment (UE), participating in a communications session, e.g., a voice communications session or other type of communications session, may have a wireless connection to a radio access network (RAN), e.g., a base station, and good network quality needs to be maintained for the wireless connection between the end user device and the radio access network. In a case in which the communication session includes two end user devices, with each end user device being connected to a radio access network, good network quality needs to be maintained at each of the wireless connections, so that the end-to-end connection quality is maintained to be able to support the ongoing communications session. A degradation in the network coverage and/or quality to an unacceptable level, for any of the end user devices with wireless connections, can result in an airlink connection being dropped, the end-to-end connection being dropped and the communications session being terminated. Such connection drops create poor user experience and often cause user frustration. This problem of an end user device experiencing a degraded level of quality in its wireless connection to a radio access network, resulting in the loss of connection and termination of the communications session is particularly relevant to mobile devices, e.g. UEs in vehicles, which may, and sometime do, move into an area of poor coverage or high interference while participating in an ongoing communications session.

Based on the above, there is a need for new methods and apparatus to identify connection drops and automatically re-initiate connection re-establishment and communications session re-establishment, when possible.

### SUMMARY

Methods and apparatus for automatically re-establishing dropped

connections and dropped communications sessions are described. An airlink connection between a user equipment (UE) and a base station is dropped, e.g., due to the UE experiencing unacceptable radio network conditions, resulting in a loss of an end device-end device connection and a dropped communications session. An analytics server receives a notification of the connection drop and evaluates information to determine when communications session re-establishment is possible. The evaluation includes evaluating measurement data corresponding to base station to UE connections, e.g. airlinks, to determine if the measurement reports indicate an acceptable level of quality to support session re-establishment, for each of the base station to UE connections involved in the end-to-end communications path for the communications session. In some embodiments, the analytics server checks with an element management system (EMS) to verify that the base stations are not experiencing any outages or other problems, which could impact successful session re-establishment. The analytics server performs successive evaluations, e.g., at predetermined time intervals, if an initial evaluation does not indicate that communications session re-establishment is possible. When the analytics server determines that the conditions for session reestablishment have been satisfied, the analytics server sends a communications session re-initiation request to the core network to trigger communications session re-initiation, as part of communications session re-establishment

An exemplary communication method, in accordance with some embodiments, includes: receiving, at a analytics server, notification of a connection drop corresponding to a communications session between a first user equipment (UE) and a second UE; determining when communications session re-establishment is possible based on base station to UE air link quality, said step of determining when communications session re-establishment is possible including determining that communications session re-establishment is possible; and in response to determining that communications session re-establishment is possible, sending a communications session re-initiation request to trigger communications session re-initiation, as part of communications session re-establishment between the first UE and the second UE.

While various features are discussed in the above summary, all features discussed above need not be supported in all embodiments and numerous variations are possible. Additional features, details and embodiments are discussed in the detailed description which follows.

### BRIEF DESCRIPTION OF THE FIGURES

FIG. 1 is a drawing of an exemplary communications system in

accordance with an exemplary embodiment.

FIG. 2 is drawing illustrating an exemplary solution flow diagram for an example in which a first UE, which is an endpoint in a communications session with a second UE, goes out of coverage with respect to a first base station or experiences a high level of interference resulting in a connection drop.

FIG. 3 is drawing illustrating an exemplary solution flow diagram for an example in which a second UE, which is an endpoint in a communications session with a first UE, goes out of coverage with respect to a second base station experiences a high level of interference resulting in a connection drop.

FIG. 4 is drawing illustrating an exemplary solution flow diagram for an example in which a first UE, which is an endpoint in a communications session with a second UE, goes out of coverage with respect a first base station or experiences a high level of interference, and the second UE goes out of coverage with respect to a second base station or experiences a high level of interference, resulting in a connection drop.

FIG. 5A is a first part of a flowchart of an exemplary method of operating a communications system in accordance with an exemplary embodiment.

FIG. 5B is a second part of a flowchart of an exemplary method of operating a communications system in accordance with an exemplary embodiment.

FIG. 5C a third part of a flowchart of an exemplary method of operating a communications system in accordance with an exemplary embodiment.

FIG. 5D is a fourth part of a flowchart of an exemplary method of operating a communications system in accordance with an exemplary embodiment.

FIG. 5E is a fifth part a flowchart of an exemplary method of operating a communications system in accordance with an exemplary embodiment.

FIG. 5 comprises the combination of FIG. 5A, FIG. 5B, FIG. 5C, FIG. 5D and FIG. 5E.

FIG. 6 is a drawing of an exemplary core network node, e.g., a device implementing an automatic re-connection function (ARF), an access and mobility management (AMF), a session management function (SMF), and/or a user plane function (UPF), in accordance with an exemplary embodiment.

FIG. 7 is a drawing of an exemplary analytics server in accordance with an exemplary embodiment.

FIG. 8 is drawing of an exemplary end user device, e.g., a user equipment (UE), cellphone, laptop with wireless interface, tablet with wireless interface, desktop PC with wireless interface, gaming device with wireless interface, WiFi user device, etc., in accordance with an exemplary embodiment.

FIG. 9 is drawing of an exemplary base station, e.g., a gNB, in accordance with an exemplary embodiment.

FIG. 10 is a drawing of an exemplary network performance server in accordance with an exemplary embodiment.

FIG. 11 is a drawing of an exemplary element management system (EMS) in accordance with an exemplary embodiment.

### DETAILED DESCRIPTION

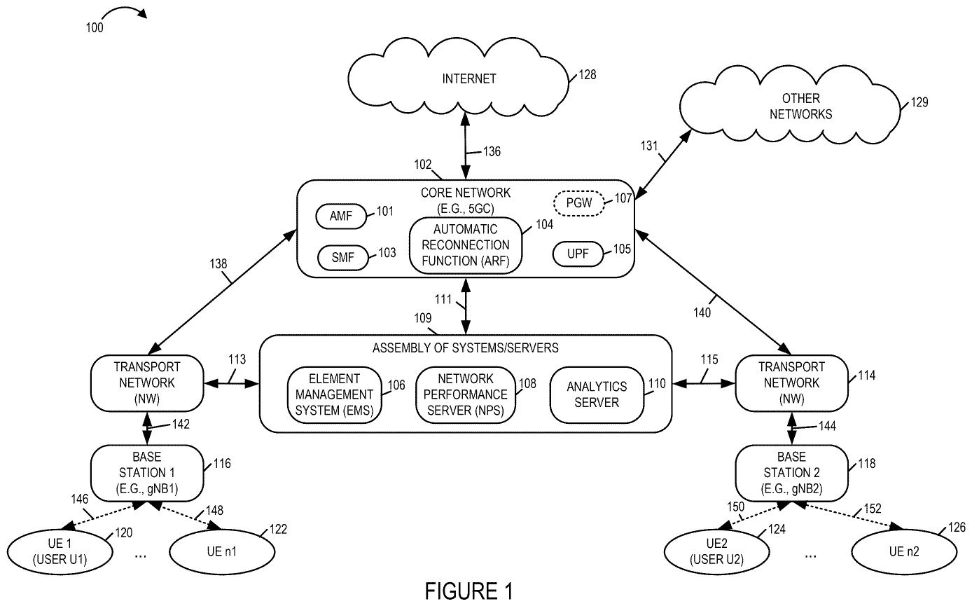

FIG. 1 is a drawing of an exemplary communications system 100 in accordance with an exemplary embodiment. Exemplary communications system 100 includes a core network 102, e.g., a 5G core network. Core network 102 includes a plurality of functions including a novel automatic reconnection function (ARF) 104, implemented in accordance with the present invention. Other functions included in the core network 102 include, e.g., an access and mobility management function (AMF) 101, a session management function (SMF) 103, and a user plane function (UPF) 105. In some embodiments, the automatic reconnection function (ARF) 104 is included as part of the SMF 103. In some, but not necessarily all embodiments, the core network 102 further includes a packet data network gateway (PGW). Exemplary communications system 100 further includes an assembly of systems/servers 109 including an element management system (EMS) 106, a network performance server (NPS) 108, and an analytics server 110. Exemplary communications system 100 further includes transport networks 112, 114, base station 1 116, e.g., gNB1, base station 2 118, e.g., gNB2, and a plurality of user equipments (UE 1 120, . . . , UE n1 122, UE 2 124, . . . , UE n2 126). In some embodiments, communications system 100 further includes other networks 129.

The elements (EMS 106, NPS 108 and analytics server 110) of assembly of systems/servers 109 are coupled to one another and to elements outside the assembly of systems/servers 109. Communications link 111 couples the assembly of systems/servers 109 to core network 102. Communications link 113 couples the assembly of systems/servers 109 to transport network 112, and communications link 115 couples the assembly of systems/servers 109 to transport network 114.

Core network 102 is coupled to the Internet 128 via communications link 136. Core network 102 is coupled to other networks 129 via communications link 131. Core network 102 is coupled to base station 1 116 via communications link 138, transport network 112 including one or more routers and/or switches, and communications link 142. Core network 102 is coupled to base station 2 118 via communications link 140, transport network 114 including one or more routers and/or switches, and communications link 144. At least some of the UEs are mobile devices, which may move throughout system 100 and be connected to different base stations at different times. Base station 1 120 is shown connected to UE 1 120 via wireless communications link 146 and is shown connected to UE n1 122 via wireless communications link 148. Base station 2 118 is shown connected to UE 2 124 via wireless communications link 150 and is shown connected to UE n2 126 via wireless communications link 152. UE 1 120 corresponds to user U1, while UE 2 124 corresponds to user U2.

In one example, UE 1 120 connects to base station 1 120 and establishes a communications session with UE 2 124, which connects to base station 2 118. The communications session is, e.g., a call between user U1 and user U2. The quality of the radio connection between UE 1 120 and base station 116 and/or the quality of the radio connection between UE 2 122 and base station 118 may be poor, e.g., a low Reference Signal Received Power (RSRP), a low Signal-to-Noise plus Interference ratio (SINR), and/or a low Reference Signal Received Quality (RSRQ), with respect to acceptable levels, resulting in a connection drop, with regard to an airlink connection between a UE and a base station, resulting in a loss of the an endpoint-to endpoint connection between UE 1 120 and UE 2 124 and ending of a communications session. In accordance with a feature of the present invention, the analytics server 110 evaluates performance, based on airlink measurement reports, and when performance is deemed acceptable, sends a re-initiation request for re-stablishing the communications session to the automatic reconnection function 104 in the core network 102, which sends signals to re-establish the wireless connections, between UEs and base stations, and re-establish the communications session. Thus, the re-initiation request is a message or signal which triggers re-establishment of the communications session which was unintentionally terminated, e.g., due to airlink connection loss or other network issues.

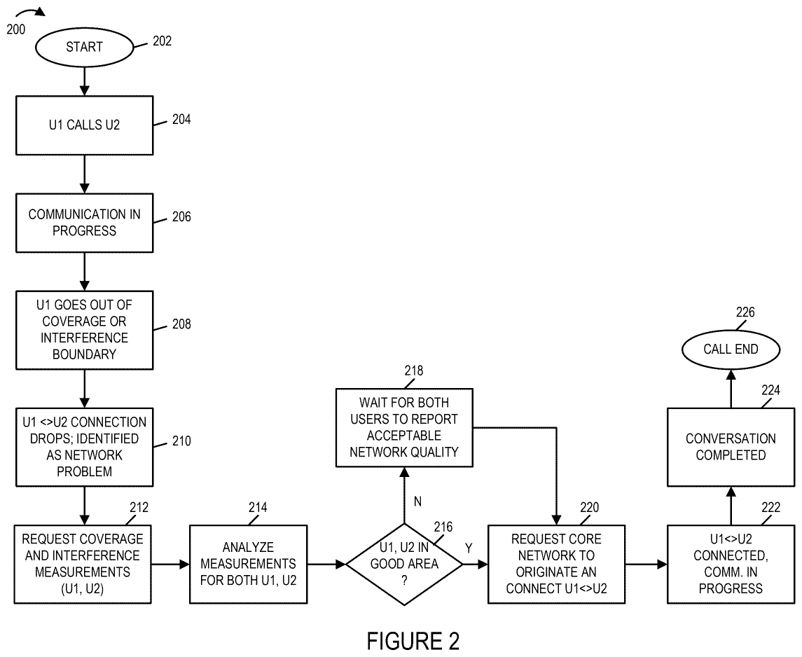

FIG. 2 is drawing 200 illustrating an exemplary solution flow diagram 200 for an example in which user U1 goes out of coverage with respect to base station 1 116 or experiences a high level of interference. Operation of the exemplary method starts in step 202, in which the communications system, e.g., communications system 100 of FIG. 1, is powered on and initialized. Operation proceeds from start step 202 to step 204, in which user U1 calls user U2. User U1, which is operating UE 1 120, initiates a call to user U2, which corresponds to UE 2 124. Thus, an endpoint-to-endpoint connection between UE 1 120 and UE 2 124 is established for supporting a communications session, e.g. a call session, between UE 1 120 and UE 2 124. More specifically, UE 1 120 establishes a wireless connection to base station 1 116, and core network 102 including SMF 103 establishes a communications session between UE 1 120 and UE 2 124. As part of establishing the communications session resources are allocated for the communications session. UE 2 124, which is currently located in the coverage area of base station 2 118, establishes and uses a wireless connection with base station 2 118. Operation proceeds from step 204 to step 206.

In step 206 communication is in progress, e.g., a conversation is in progress between user U1 and user U2, in which user data traffic, corresponding to the communications session, which is a call session, is exchanged over a communication path between UE 1 120 and UE 2 124, said communication path including wireless connection 146, base station 1 116, core network 102 including one or more UPFs, base station 2 118 and wireless connection 150.

Operation proceeds from step 206 to step 208. In step 208 user U1 and UE 1 120 goes out of coverage or over an interference boundary. For example, in step 208 one or more or all of the following occurs: i) UE 1 measured RSRP<x dBm, ii) UE 1 measured SINR<y dB, and iii) UE 1 measured RSRQ<z dB, where x, y and z are threshold criteria, e.g., due to movement of UE 1 120 to a new location and/or due to interference being experienced at UE 1 120. Thus, in step 206 the airlink connection between UE 1 120 and BS1 116 becomes unacceptable. Operation proceeds from step 208 to step 210.

In step 210 the U1<>U2 (UE 1 120 to UE 2 124) connection drops and is identified as a network problem, e.g., radio network problem, e.g., a problem with the airlink connection between UE 1 120 and BS 1 116. Operation proceeds from step 210 to step 212.

In step 212 the base stations (base station 1 116, base station 2 118) request coverage and interference measurements from UEs (UE 1 120, UE 2 124), respectively. The UEs (UE 1 120, UE 2 124) perform measurements, as requested, generate measurement reports, send the generated measurement reports to the base stations (BS 1 116, BS 2 118), respectively. The base stations (BS 1 116, BS 2 118), which receive the measurement reports from the UEs (UE 1 120, UE 2 124), respectively, send the measurement reports to a network performance server 108. The analytics server 110 requests the measurement information from the network performance server 108 and is provided the requested information. Operation proceeds from step 212 to step 214. In step 214, the network performance server 108 sends an analysis request to the analytics server 110 to request analysis of the measurements for both UE 1 120 and UE 2 124, and the analytics server 110, which receives the request, performs the requested analysis. In some embodiments the analysis includes determining if RSRP, SINR, and RSRQ are above predetermined acceptable levels for supporting the communications session between UE 1 120 and UE 2 124 for both UE 1 120 and UE 2 142, e.g., indicating that radio network performance is acceptable for both wireless link 146 between UE 1 120 and base station 1 120 and wireless link 150 between UE 2 124 and base station 2 118. Operation proceeds from step 214 to step 216.

In step 216, the analytics server 110 determines if the analysis indicates that both UE 1 120 and UE 2 124 are in located good areas (areas with acceptable signal quality to support the communications session), e.g., based on acceptable measured values for RSRP, SINR and RSRQ. If the determination is that both UEs (UE 1 120 and UE 2 124) are not in good areas, then operation proceeds from step 216 to step 218, in which system waits for both users (UE 1 120 and UE 2 124) to report acceptable network quality before proceeding with a re-connection attempt. However, if the determination is that both UEs (UE 1 120 and UE 2 124) are in good areas, then operation proceeds from step 216 to step 220. In step 220 the analytics server 110 requests the core network 102 to originate a U1<>U2 connection (UE 1 120 to UE 2 124) connection. For example, analytics server 110 generates and sends a re-initiation request message to the core network, e.g., to the automatic reconnection function 104 in the SMF 103 of the core network 102, which receives the request, and sends call/session establishment signaling to both base station 1 116 and base station 2 118, which subsequently establish wireless connections with UE 1 120 and UE 2 124, respectively, for reestablishing the dropped connection between UE 1 120 (U1) and UE 2 124 (U2) and for re-establishing and supporting a communications session between UE 1 120 and UE 2 124. Operation proceeds from step 220 to step 222.

In step 222, UE 1 120 and UE 2 124 are connected (via U1<>U2 endpoint-to-endpoint connection), the communications session, e.g., call session, is re-established and communications are in progress, e.g., a conversation is in progress between user U1 and user U2, in which user data traffic, corresponding to the re-established communications session, which is a call session, is exchanged over a communication path between UE 1 120 and UE 2 124, said communication path including wireless connection 146, base station 1 116, core network 102 including one or more UPFs, base station 2 118 and wireless connection 150. Operation proceeds from step 222 to step 224, in which the conversation is completed, e.g., U1 or U2 ends the call and hangs up. Operation proceeds from step 224 to step 226 in which the session, e.g., call, is ended and resources supporting the call are released, e.g. by the core network 102 and base stations 116, 118.

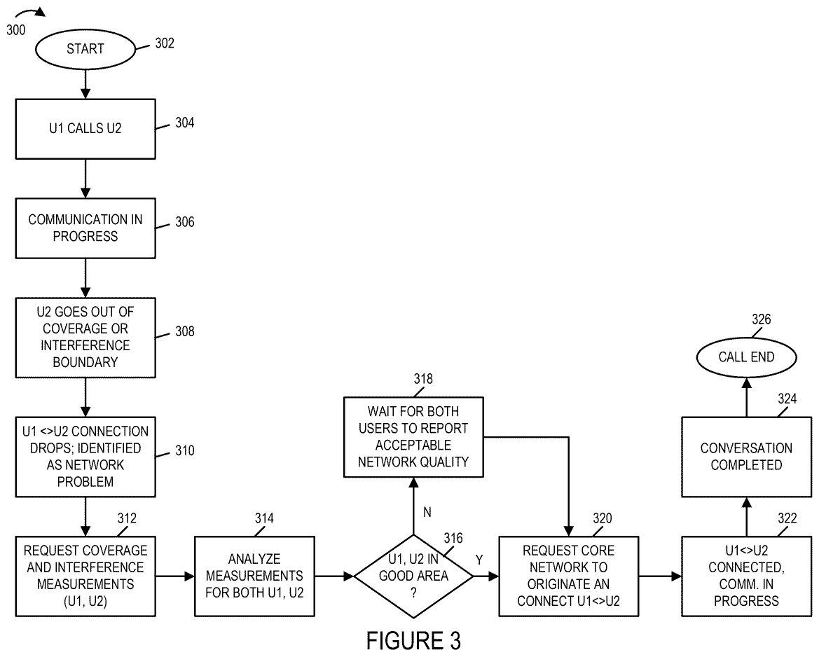

FIG. 3 is drawing 300 illustrating an exemplary solution flow diagram 300 for an example in which user U2 goes out of coverage with respect to base station 2 118 or experiences a high level of interference. Operation of the exemplary method starts in step 302, in which the communications system, e.g., communications system 100 of FIG. 1, is powered on and initialized. Operation proceeds from start step 302 to step 304, in which user U1 calls user U2. User U1, which is operating UE 1 120, initiates a call to user U2, which corresponds to UE 2 124. Thus, a connection between UE 1 120 and UE 2 124 is established for supporting a communications session, e.g. a call session, between UE 1 120 and UE 2 124. UE 1 120 establishes a wireless connection to base station 1 116, and core network 102 including a SMF establishes a communications session between UE 1 120 and UE 2 124. As part of establishing the communications session resources are allocated for the communications session. UE 2 124, which is currently located in the coverage area of base station 2 118, establishes and uses a wireless connection with base station 2 118. Operation proceeds from step 304 to step 306. In step 306 communication is in progress, e.g., a conversation is in progress between user U1 and user U2, in which user data traffic, corresponding to the communications session, which is a call session, is exchanged over a communication path between UE 1 120 and UE 2 124, said communication path including wireless connection 146, base station 1 116, core network 102 including one or more UPFs, base station 2 118 and wireless connection 150.

Operation proceeds from step 306 to step 308. In step 308 user U2 and UE 2 124 goes out of coverage or over an interference boundary. For example, in step 308 one or more or all of the following occurs: i) UE 2 measured RSRP<x dBm, ii) UE 2 measured SINR<y dB, and iii) UE 2 measured RSRQ<z dB, e.g., due to movement of UE 2 124 to a new location and/or due to interference being experienced at UE 2 124. Operation proceeds from step 308 to step 310.

In step 310 the U1<>U2 (UE 1 120 to UE 2 124) connection drops and is identified as a network problem, e.g., a radio network problem, a problem with the airlink connection between UE 2 124 and BS 2 118. Operation proceeds from step 310 to step 312.

In step 312 the base stations (base station 1 116, base station 2 118) request coverage and interference measurements from UEs (UE 1 120, UE 2 124), respectively. The UEs (UE 1 120, UE 2 124) perform measurements, as requested, generate measurement reports, send the generated measurement reports to the base stations (BS 1 116, BS 2 118), respectively. The base stations (BS 1 116, BS 2 118), which receive the measurement reports from the UEs (UE 1 120, UE 2 124), respectively, send the measurement reports to a network performance server 108. The analytics server 110 requests the measurement information from the network performance server 108 and is provided the requested information. Operation proceeds from step 312 to step 314. In step 314, the network performance server 108 sends an analysis request to the analytics server 110 to request analysis of the measurements for both UE 1 120 and UE 2 124, and the analytics server 110, which receives the request, performs the requested analysis. In some embodiments the analysis includes determining if RSRP, SINR, and RSRQ are above predetermined acceptable levels for supporting the communications session between UE 1 120 and UE 2 124 for both UE 1 120 and UE 2 122, e.g., indicating that radio network performance is acceptable for both wireless link 146 between UE 1 120 and base station 1 120 and wireless link 150 between UE 1 124 and base station 2 118. Operation proceeds from step 314 to step 316.

In step 316, the analytics server 110 determines if the analysis indicates that both UE 1 120 and UE 2 124 are in located good areas (areas with acceptable signal quality to support the communications session), e.g., based on acceptable measured values for RSRP, SINR and RSRQ. If the determination is that both UEs (UE 1 120 and UE 2 124) are not in good areas, then operation proceeds from step 316 to step 318, in which system waits for both users (UE 1 120 and UE 2 124) to report acceptable network quality before proceeding with a re-connection attempt. However, if the determination is that both UEs (UE 1 120 and UE 2 124) are in good areas, then operation proceeds from step 316 to step 320. In step 320 the analytics server 110 requests the core network 102 to originate a U1<>U2 connection (UE 1 120 to UE 2 124) connection. For example, analytics server 110 generates and sends a re-initiation request message to the core network, e.g., to the automatic reconnection function 104 in the SMF 103 of the core network 102, which receives the request, and sends call/session establishment signaling to both base station 1 116 and base station 2 118, which subsequently establish wireless connections with UE 1 120 and UE 2 124, respectively, for reestablishing the dropped endpoint-endpoint connection between UE 1 120 (U1) and UE 2 124 (U2) and for supporting a re-established communications session between UE 1 120 and UE 2 124. Operation proceeds from step 320 to step 322.

In step 322, UE 1 120 and UE 2 124 are connected (U1<>U2) for resuming the communications session, e.g., call session, as a re-established communications session and communications are in progress, e.g., a conversation is in progress between user U1 and user U2, in which user data traffic, corresponding to the re-established communications session, which is a call session, is exchanged over a communication path between UE 1 120 and UE 2 124, said communication path including wireless connection 146, base station 1 116, core network 102 including one or more UPFs, base station 2 118 and wireless connection 150. Operation proceeds from step 322 to step 324, in which the conversation is completed, e.g., U1 or U2 ends the call and hangs up. Operation proceeds from step 324 to step 326 in which the re-established communications session, e.g., call, is ended and resources supporting the call are released, e.g. by the core network 102 and base stations 116, 118.

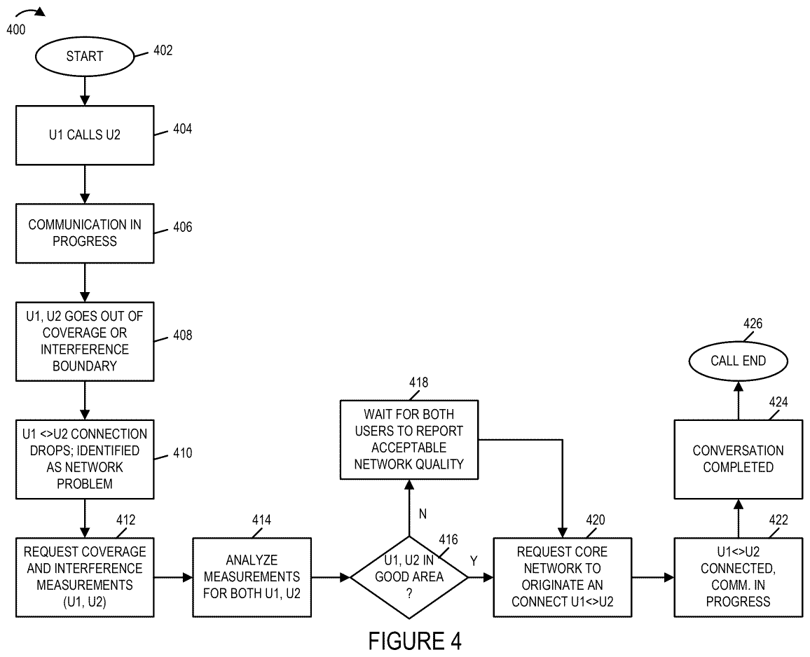

FIG. 4 is drawing 400 illustrating an exemplary solution flow diagram 400 for an example in which U1 goes out of coverage with respect to base station 1 116 or experiences a high level of interference and U2 goes out of coverage with respect to base station 2 118 or experiences a high level of interference. Operation of the exemplary method starts in step 402, in which the communications system, e.g., communications system 100 of FIG. 1, is powered on and initialized. Operation proceeds from start step 402 to step 404, in which user U1 calls user U2. User U1, which is operating UE 1 120, initiates a call to user U2, which corresponds to UE 2 124. Thus, a connection between UE 1 120 and UE 2 124 is established for supporting a communications session, e.g. a call session, between UE 1 120 and UE 2 124. UE 1 120 establishes a wireless connection to base station 1 116, and core network 102 including a SMF establishes a communications session between UE 1 120 and UE 2 124. As part of establishing the communications session resources are allocated for the communications session. UE 2 124, which is currently located in the coverage area of base station 2 118, establishes and uses a wireless connection with base station 2 118. Operation proceeds from step 404 to step 406. In step 406 communication is in progress, e.g., a conversation is in progress between user U1 and user U2, in which user data traffic, corresponding to the communications session, which is a call session, is exchanged over a communication path between UE 1 120 and UE 2 124, said communication path including wireless connection 146, base station 1 116, core network 102 including one or more UPFs, base station 2 118 and wireless connection 150.

Operation proceeds from step 406 to step 408. In step 408 both: i) user U1 and UE 1 120 goes out of coverage with regard to base station 1 116 or over an interference boundary and ii) U2 and UE 2 124 goes out of coverage with regard to base station 2 118 or over an interference boundary. For example, in step 408 one or more or all of the following occurs with regard to UE 1 occurs: i) UE 1 measured RSRP<x dBm, ii) UE 1 measured SINR<y dB, and iii) UE 1 measured RSRQ<z dB, e.g., due to movement of UE 1 120 to a new location and/or due to interference being experienced at UE 1 120; and one or more or all of the following occurs with regard to UE 2 occurs: i) UE 2 measured RSRP<x dBm, ii) UE 2 measured SINR<y dB, and iii) UE 2 measured RSRQ<z dB, e.g., due to movement of UE 2 124 to a new location and/or due to interference being experienced at UE 2 124. Operation proceeds from step 408 to step 410.

In step 410 the U1<>U2 (UE 1 120 to UE 2 124) connection drops and is identified as a network problem, e.g., a radio network problem, e.g., a problem with the airlink connection between UE 1 120 and BS 1 116 and a problem with the airlink connection between UE 2 124 and BS 2 118. Operation proceeds from step 410 to step 412.

In step 412 the base stations (base station 1 116, base station 2 118) request coverage and interference measurements from UEs (UE 1 120, UE 2 124), respectively. The UEs (UE 1 120, UE 2 124) perform measurements, as requested, generate measurement reports, send the generated measurement reports to the base stations (BS 1 116, BS 2 118), respectively. The base stations (BS 1 116, BS 2 118), which receive the measurement reports from the UEs (UE 1 120, UE 2 124), respectively, send the measurement reports to a network performance server 108. The analytics server 110 requests the measurement information from the network performance server 108 and is provided the requested information. Operation proceeds from step 412 to step 414. In step 414, the network performance server 108 sends an analysis request to the analytics server 110 to request analysis of the measurements for both UE 1 120 and UE 2 124, and the analytics server 110, which receives the request, performs the requested analysis. In some embodiments the analysis includes determining if RSRP, SINR, and RSRQ are above predetermined acceptable levels for supporting the communications session between UE 1 120 and UE 2 124 for both UE 1 120 and UE 2 142, e.g., indicating that radio network performance is acceptable for both wireless link 146 between UE 1 120 and base station 1 120 and wireless link 150 between UE 2 124 and base station 2 118. Operation proceeds from step 414 to step 416.

In step 416, the analytics server 110 determines if the analysis indicates that both UE 1 120 and UE 2 124 are in located good areas (areas with acceptable signal quality to support the communications session), e.g., based on acceptable measured values for RSRP, SINR and RSRQ. If the determination is that both UEs (UE 1 120 and UE 2 124) are not in good areas, then operation proceeds from step 416 to step 418, in which system waits for both users (UE 1 120 and UE 2 124) to report acceptable network quality before proceeding with a re-connection attempt. However, if the determination is that both UEs (UE 1 120 and UE 2 124) are in good areas, then operation proceeds from step 416 to step 420. In step 420 the analytics server 110 requests the core network 102 to originate a U1<>U2 connection (UE 1 120 to UE 2 124) connection. For example, analytics server 110 generates and sends a re-initiation request message to the core network, e.g., to the automatic reconnection function 104 in the SMF 103 of the core network 102, which receives the request, and sends call/session establishment signaling to both base station 1 116 and base station 2 118, which subsequently establish wireless connections with UE 1 120 and UE 2 124, respectively, for supporting a re-established communications session between UE 1 120 and UE 2 124, for reestablishing the dropped endpoint-to endpoint connection between UE 1 120 (U1) and UE 2 124 (U2). Operation proceeds from step 420 to step 422.

In step 422, UE 1 120 and UE 2 124 are connected (via re-established endpoint to endpoint U1<>U2 connection) for resuming the communications session, e.g., call session, as a re-established communications session and communications are in progress, e.g., a conversation is in progress between user U1 and user U2, in which user data traffic, corresponding to the re-established communications session, which is a call session, is exchanged over a communication path between UE 1 120 and UE 2 124, said communication path including wireless connection 146, base station 1 116, core network 102 including one or more UPFs, base station 2 118 and wireless connection 150. Operation proceeds from step 422 to step 424, in which the conversation is completed, e.g., U1 or U2 ends the call and hangs up. Operation proceeds from step 424 to step 426 in which the re-established session, e.g., call, is ended and resources supporting the call are released, e.g., by the core network 102 and base stations 116, 118.

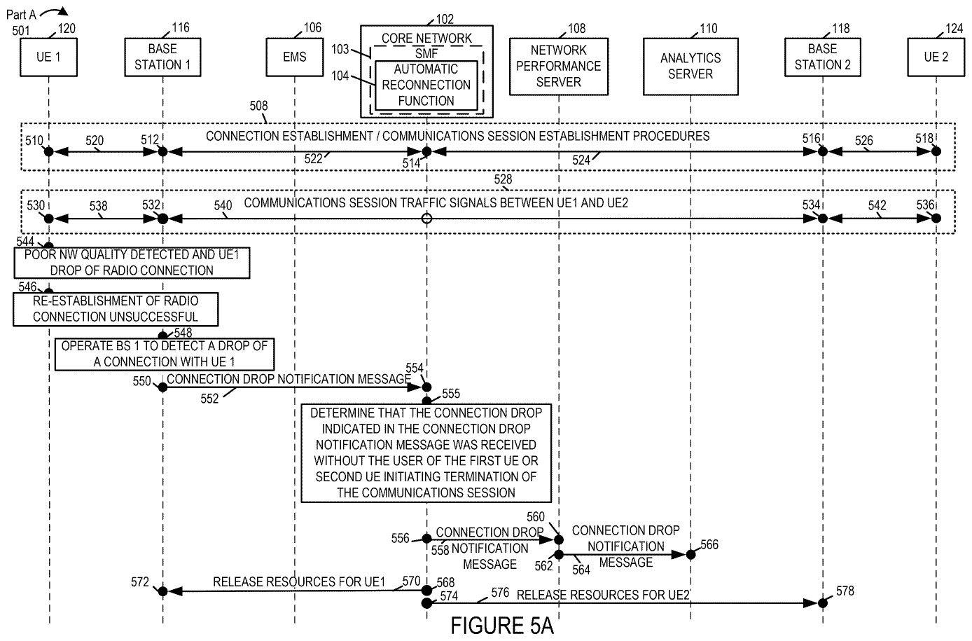

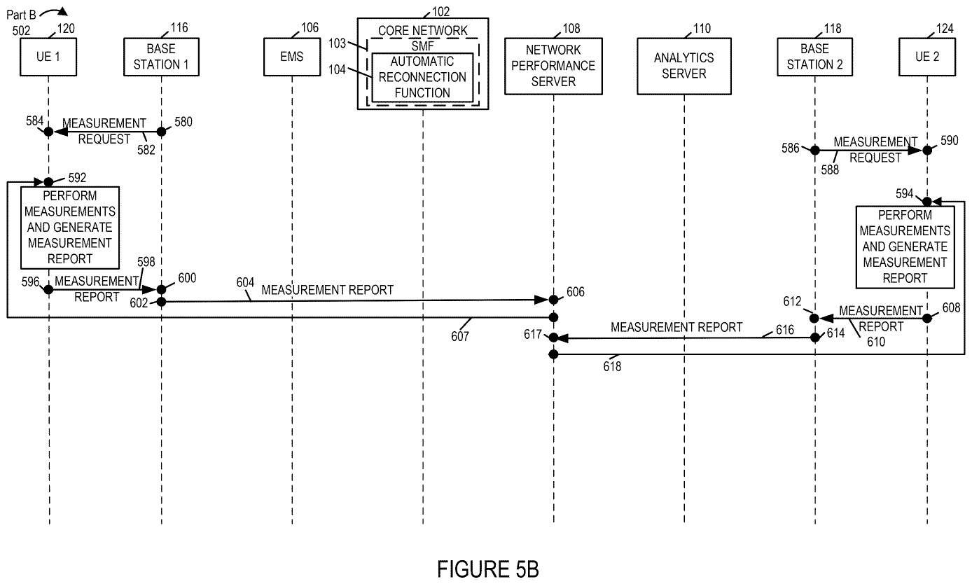

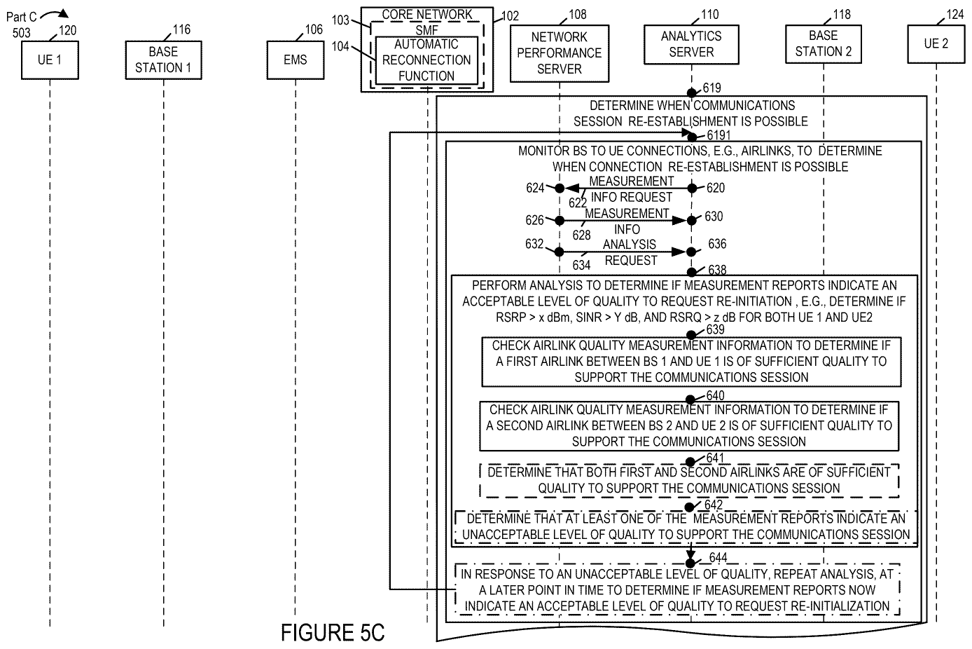

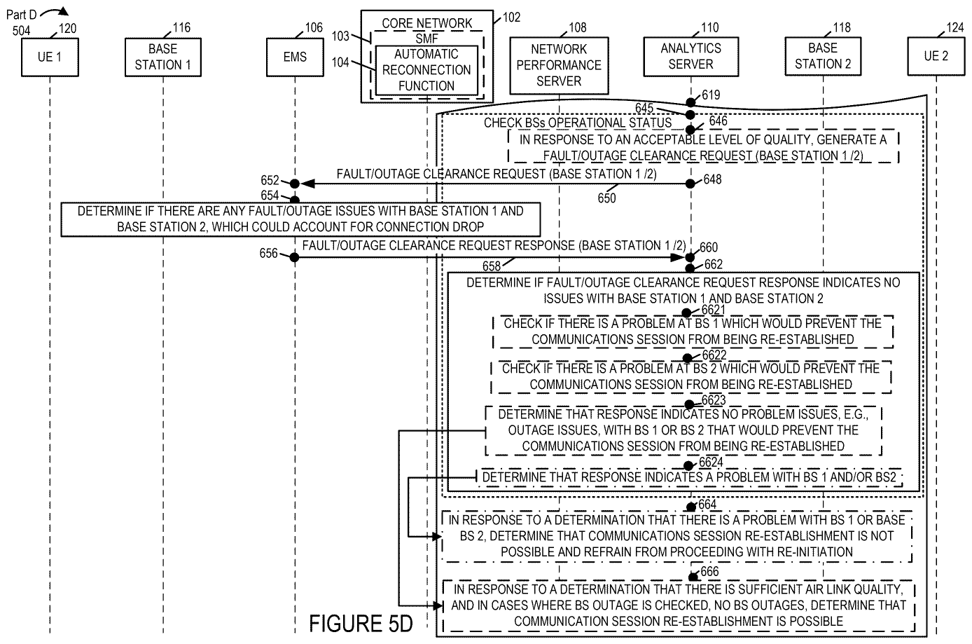

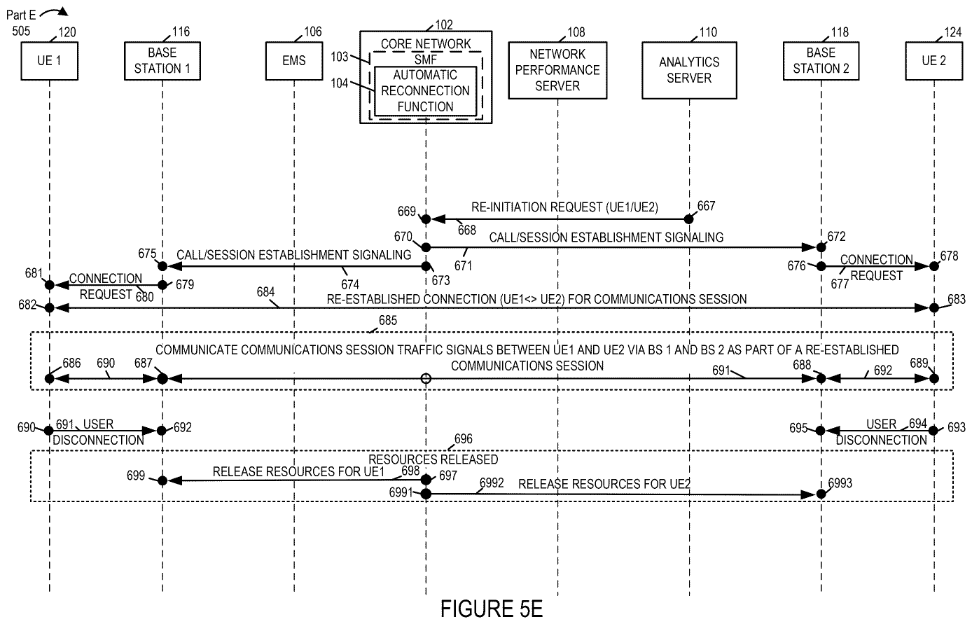

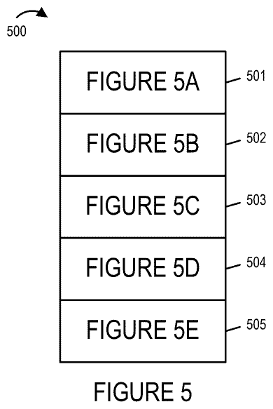

FIG. 5, comprising the combination of FIG. 5A, FIG. 5B, FIG. 5C, FIG. 5D and FIG. 5E, is a signaling diagram 500, including Part A 501, Part B 502, Part C 503, Part D 504, and Part E 505, of an exemplary method of operating a communications system, e.g., communications system 100 of FIG. 1, in accordance with an exemplary embodiment. FIG. 5 includes exemplary elements: UE 1 120, base station 1 (BS 1 ) 116, e.g., gNB1, EMS 106, core network 102 including SMF 103 and automatic reconnection function 104, network performance server 108, analytics server 110, base station 2 (BS 2 ) 118, e.g., gNB2, and UE 2 124. In some embodiments, automatic reconnection function (ARF) 104 is includes as part of another function, e.g., SMF 103, with the core network 102. In other embodiments, ARF 104 is implemented as a sperate entity.

In step 508 the communications system 100 performs connection establishment/communications session establishment procedures to establish an end-end to connection and a communications session between UE 1 120 and UE 2 124. The procedures of step 508 include establishing a wireless connection between UE 1 120 and base station 1 116 and establishing a wireless connection between UE 2 124 and base station 2 118. Step 508 includes steps 510, 512, 514, 516 and 518. In steps 510, 512, 514, 516 and 518, the various entities (UE 1 120, BS 1 116, core network 102, base station 2 118, and UE 2 124) are operated, respectively, to send/receive and process connection establishment/communications session establishment signals, e.g., signals 520, 522, 524, 526 as shown.

Block 528 illustrates the communication of traffic signals between UE 1 120 and UE 2 124, corresponding to the established end to end connection between UE 1 120 and UE 2 124 for the established communications session. In step 530 UE 1 120 send/receives wireless signals 538 over a wireless connection with base station 1 116. In step 532 base station 1 116 sends/receives wireless signals 538 over a wireless connection with UE 1 120. In step 532 base station 1 116 also sends/receives signals 530 over a connection with base station 2 118 via core network 102, e.g. via one or more UPF(s) in the core network 102. In step 534 base station 2 118 sends/receives signals 540 over a connection with base station 1 116 via core network 102. In step 534 base station 2 118 also sends/receives wireless signals 542 over a wireless connection with UE 2 124. In step 536 UE 2 124 send/receives wireless signals 542 over a wireless connection with base station 2 118.

In step 544 UE detects poor network (NW) quality, e.g., one or more of RSRP, SINR, and RSRQ are measured by UE 1 120 and determined by UE 1 120 to be below acceptable levels to support the communications session between UE 1 120 and UE 2 124, and UE 1 120 drops the radio connection with base station 1 116. In step 544 the re-establishment of the radio connection by UE 1 120 is unsuccessful.

In step 548 base station 1 116 detects a drop of the radio connection (e.g., a wireless connection between BS 1 116 and UE 1 120 that was being used to support the communications session) with UE 1 120, e.g., base station 1 116 fails to receive acknowledgement signals of downlink traffic signals sent to UE 1 120 as part of the communications session and determines that the radio connection has been dropped.

In step 550 the base station 1 116 generates and sends a connection drop notification message 552 to core network 102, e.g., to the automatic reconnection function (ARF) 104 in the core network 102. In step 554 core network 102, e.g., the ARF 104 of the core network 102, receives the connection drop notification message and recovers the communicated information.

In step 555, the core network 102 determines that the connection drop notification indicated in the connection drop notification message 552 was received without the user of the first UE or the user of second UE initiating termination of the communications session (e.g., as would have been indicated by the core network 102 receiving communications session related termination signaling relating to the communications session prior to the connection drop notification message (552) corresponding to the dropped communications session). Operation proceeds from step 555 to step 556 in which the core network 102 generates and sends a connection drop notification message 558 to network performance server 108. In various embodiments, connection drop notification message 558 is a forwarded copy of connection drop notification message 552. In step 560 network performance server 108 receives the connection drop notification message 558 and recovers the communicated information. Operation proceeds from step 560 to step 562 in which the network performance server 108 generates and sends a connection drop notification message 564 to analytics server 110. In various embodiments, connection drop notification message 564 is a forwarded copy of connection drop notification message 558. In step 566 analytics server 110 receives the connection drop notification message 564 and recovers the communicated information. The received connection drop notification message 564 corresponds to a communications session, e.g., a voice, data or video communications session, between UE 1 120 and UE 2 124. The received connection drop notification message 564 informs the analytics server 110 of a connection drop, e.g., a non-UE initiated connection drop of a communications session in which at least UE 1 120 and U2 124 are connection end points. The connection drop notification message 564, in some embodiments, includes information, e.g., device identifiers, corresponding to UE 1 120 and UE 2 124 and information identifying BS 1 116 as being used as a network point of attachment by UE 1 120, and information identifying BS 2 118 as being used a network point of attachment by UE 2 124. In some embodiments, the connection drop notification message 564 includes information identifying an end-to-to end connection identifier, identifying the end-to end connection being dropped. In some embodiments the connection drop notification message includes a session identifier identifying the communication session corresponding to the end to end connection drop. In some embodiments, the connection drop notification message includes information identifying the type of communications session, which has been ended as a result of the connection drop.

In step 568 core network 102 generates and sends message 570 to base station 1 116, to notify base station 1 1116 to release resources for UE 1 120. In step 572 base station 1 116 receives message 570, recovers the communicated information and releases resources for UE 1 120, e.g. resources which were being used to support the connection and communications session between UE 1 120 and UE 2 124. In step 574 core network 102 generates and sends message 576 to base station 2 118, to notify base station 2 118 to release resources for UE 2 124. In step 578 base station 2 118 receives message 576, recovers the communicated information and releases resources for UE 2 124, e.g. resources which were being used to support the connection and communications session between UE 1 120 and UE 2 124.

In step 580 base station 1 116 generates and sends measurement request message 582 to UE 1 120. In some embodiments, measurement request message 582 requests measurements reports from UE 1 120 at a higher reporting rate and/or with more detailed information, than is typically used to report measurement information for a typical UE which is not experiencing a problem with regard to radio communications with the base station 1 116. In step 584, UE 1 120 receives measurement request message 582, and processes the request.

In step 586 base station 2 118 generates and sends measurement request message 588 to UE 2 124. In step 590, UE 2 124 receives measurement request message 588, and processes the request. In some embodiments, measurement request message 588 requests measurements reports from UE 2 124 at a higher reporting rate and/or with more detailed information, than is typically used to report measurement information for a typical UE which is not experiencing a problem with regard to radio communications with the base station 2 118. In step 590, UE 2 124 receives measurement request message 588, and processes the request.

In step 592, in response to the received measurement request of message 582, UE 1 120 performs measurements and generates a measurement report, e.g., of RSRP, SINR, and RSRQ with regard to received signals, e.g., received reference signals, from base station 1 116. In step 596 UE 1 120 sends the generated measurement report 598 to base station 1 116. In step 600 base station 1 116 receives the measurement report 598 and recovers the communicated information. In step 602 base station 1 116 generates and sends measurement report 604 to network performance server 108, which in step 606, receives the measurement report, recovers the communicated information and stores the recovered information. In embodiments, measurement report 604 is a forwarded copy of measurement report 598. In some embodiments, measurement report 604 includes aggregated and/or processed information from one or more measurement reports 598 from UE 1 120. In some embodiments, measurement report 604 includes information pertaining to multiple UEs, which are collecting and reporting data to base station 1 116 and UE 1 120 is one of those UEs.

In step 594, in response to the received measurement request of message 588, UE 2 124 performs measurements and generates a measurement report, e.g., of RSRP, SINR, and RSRQ with regard to received signals, e.g., received reference signals, from base station 2 118. In step 608 UE 2 124 sends the generated measurement report 610 to base station 2 118. In step 612 base station 2 118 receives the measurement report 610 and recovers the communicated information. In step 614 base station 2 118 generates and sends measurement report 616 to network performance server 108, which in step 617, receives the measurement report, recovers the communicated information and stores the recovered information. In embodiments, measurement report 616 is a forwarded copy of measurement report 610. In some embodiments, measurement report 616 includes aggregated and/or processed information from one or more measurement reports 610 from UE 2 124. In some embodiments, measurement report 616 includes information pertaining to multiple UEs, which are collecting and reporting data to base station 2 118 and UE 2 124 is one of those UEs.

Arrow 607 indicates the process of UE 1 120 performing measurements, generating a measurement report, sending the measurement report to base station 1 116, and communicating the UE 1 120 measurement report information to the network performance server 108 is performed repetitively, if needed. Similarly, arrow 618 indicates the process of UE 2 124 performing measurements, generating a measurement report, sending the measurement report to base station 2 118, and communicating the UE 2 124 measurement report information to the network performance server 108 is performed repetitively, if needed.

In step 619 the analytics server 110 determines when communications session re-establishment is possible based on base station to UE air link quality (e.g., quality of a first airlink between BS 1 116 and UE 1 120 and quality of a second airlink between BS 2 118 and UE 2 124). Step 619 includes step 6119, in which the analytics server 110 monitors base station to UE connections, e.g., airlinks, to determine when connection re-establishment is possible. In some embodiments, step 619 includes optional step 645 including optional steps 646, 648, 660, 662 and 664, in which the analytics server 110 checks with EMS 106 to determine if there is a base station 1 116 outage or a base station 2 outage, which may be the cause of the communications session failure and/or may prevent communications session re-establishment.

In step 620 analytics server 110 generates and sends measurement information request 622 to network performance server 108, requesting information pertaining to: i) a first airlink between UE 1 120 and base station 1 116 and ii) a second airlink between UE 2 124 and base station 2 118. In step 624, network performance server 108 receives measurement information request 622 and processes the request. In step 626, network performance server 108, in response to the request 622, generates and sends measurement information 628 to analytics server 110. In step 630 the analytics server 110 receives the requested measurement information 628 and stores the received measurement information. The measurement information 628 received in step 630 includes airlink quality information corresponding to: i) the airlink (146) between BS 1 116 and UE 1 120, ii) the airlink (150) between BS 2 118 and UE 2 124, or iii) both the airlink (146) between BS 1 116 and UE 1 120 and the airlink (150) between BS2 118 and UE 2 124. The measurement information 628 includes airlink measurements made by at least one of UE 1 120 and UE 2 124.

In step 632, the network performance server 108 generates and sends an analysis request 634 to analytics server 110, said analysis request 634 requesting the analytics server 110 to determine if the measurement reports indicate an acceptable level of quality to request re-initiation for the connection and communications session between UE 1 120 and UE 2 122. In step 636 the analytics server 110 receives the analysis request 634. Operation proceeds from step 636 to step 638.

In step 638 the analytics server 110 performs an analysis to determine if measurement reports indicate an acceptable level of quality to request re-initiation, e.g., determine if RSRP>x dBm, SINR>y dB, and RSRQ>z for both UE 1 120 and UE 2 124. Step 638 includes step 639 and 640. In step 639 the analytics server 110 checks airlink quality measurement information to determine if a first airlink between base station 1 116 and UE 1 120 is of sufficient quality to support the communications session. In step 640 the analytics server 110 checks airlink quality measurement information to determine if a second airlink between base station 2 118 and UE 2 124 is of sufficient quality to support the communications session. Based on the results of the checks of step 639 and 640, one of steps 641 and 642 is performed. In step 641 the analytics server 110 determines that both the first and second airlinks are of sufficient quality to support the communications session (e.g., checks determine that the quality metric or metrics associated with each of the first and second airlinks equals or exceeds a corresponding quality threshold used to determine if the communications session can be supported). Thus, in step 641 the analytics server 1110 determines based on checks (e.g., airlink quality checks) that there is not a problem at either BS 1 116 or BS 2 118 (with the airlink146 to UE 1 120 or the airlink 150 to UE 2 124) that would prevent the communications session from being re-established. Alternatively, in step 642, the analytics server 110 determines that at least one of the measurement reports indicate an unacceptable level of quality to support the communications session. Operation proceeds from step 642 to step 644. In step 644, in response to an unacceptable level of quality, the analytics server 110 is operated to repeat the analysis, at a later point in time to determine if measurements now indicate an acceptable level of quality to request re-initialization. Operation proceeds from step 644 to step 6191. In some embodiments, air link quality can be retested, by the analytics server 110, for a pre-determined duration and/or a predetermined number of times, if necessary (e.g., due to unacceptable quality determinations), before terminating the checking. In some embodiments, there is a predetermined time interval between each analytics server 110 air link set evaluation, e.g., to allow for stabilization and to limit the amount of data collection, measurements and processing. For example, in one embodiment, the air link quality is checked (evaluated by the analytics server) at 10 second intervals as necessary, and the check can be performed up to a maximum number of times, e.g. 3 times.

Returning to step 642, operation proceeds from step 642 to either step 645 or step 666, depending on the particular embodiment. If the optional checks of BSs operational status is to be performed, then operation proceeds from step 642 to step 645. However, if optional step of checking BSs operational status is not to be performed, e.g., is to be bypassed, then operation proceeds from step 642 to step 666.

Returning to step 645, step 645 includes steps 646, 648, 660 and 662. In step 646, in response to an acceptable level of quality having been determined in step 642, the analytics server 110 generates a fault, outage, and/or alarm clearance request message 650 to check: i) if there are any fault/outage/alarm issues with base station 1 and ii) if there are any fault, outage and/or alarm issues with base station 2. In step 648 analytics server 110 sends the generated fault/outage/alarm clearance request message 650, which includes information identifying base station 1 116 and information identifying base station 2 118, to EMS 106. In step 652 the EMS receives a fault,, outage and/or alarm clearance request (base station 1/base station 2) message 650. In step 654 EMS 106, determines, e.g., based on information in a fault, outage, and/or alarm/device status database (which may be included in EMS 106 or may be accessed by EMS 106), i) if there are any fault, outage and/or alarm issues with base station 1 116 which would prevent communications session re-establishment and ii) if there are any fault, outage, and/or alarm issues with base station 2 118, which would prevent communications session re-establishment. In step 656, EMS 106 generates a fault/outage clearance request response message 658, which includes an indication of the results of the determinations, e.g., i) there are no issues, e.g., no faults, outages or alarms, with regard to base station 1 116 or there is a detected fault, outage and/or alarm with base station 1 116 which would prevent communications session re-establishment and ii) i) there are no issues, e.g., no faults, outages and/or alarms, with regard to base station 2 118 or there is a detected fault, outage, and/or alarm with base station 2 118 which would prevent communications session re-establishment, and sends the fault, outage and/or alarm clearance request response message 658 to analytics server 110.

In step 660 the analytics server 110 receives the fault, outage and/or alarm clearance request response message 658 and recovers the communicated information. Step 662 includes steps 6621, 6622, 6623 and 6624. In step 6621 the analytics server 110 checks, e.g., using the received information in message 658, if there is a problem at base station 1 116 which would prevent the communications session from being re-established. In step 6622 the analytics server 110 checks, e.g., using the received information in message 658, if there is a problem at base station 2 118 which would prevent the communications session from being re-established. Based on the results of the checks of step 6621 and 6622, either step 6623 or step 6624 is performed. In step 6623 the analytics server 110 determines that the response indicates no problem issues, e.g., outage issues, with base station 1 116 or base station 2 118 that would prevent the communications session from being re-established. Alternatively, in step 6624, the analytics server 110 determines that the response indicates a problem, e.g., outage, with base station 1 116 and/or base station 2 118. Operation proceeds from step 6624 to step 664. In step 664, the analytics server 110, in response to a determination that there is a problem with base station 1 116 or base station 2 118, determines that communication session re-establishment is not possible and refrains from proceeding with re-initiation. Operation proceeds from step 6623 to step 666 or, in cases in which BS outages is not checked, operation proceeds from step 641 to step 666. In step 666, in response to a determination that there is sufficient air link quality, and in cases, where base station outage is checked and there are no BS outages, the analytics server 110 determines that communications session re-establishment is possible. Operation proceeds from step 666 to step 667.

In step 667, the analytics server 110 generates and sends a communications session re-initiation request (UE 1/UE 2 ) message 668 to the core network 102 (e.g., to the automatic reconnection function (ARF) 104 of the core network 102) to trigger re-initiation of the communications session between UE 1 120 and UE 2 124, as part of communications session re-establishment. In some embodiments, automatic reconnection function 104 of the core network 102, is included as part of SMF 103. In some embodiments, the re-initiation request is processed by the ARF 104. In some embodiments, the re-initiation request message 668 includes information identifying UE 1 120 and UE 2 124 and/or includes an identifier identifying the communications session which was dropped. In step 669 core network 102, e.g., the automatic reconnection function 104 of the core network 102 receives the re-initiation request 668 requesting that the core network proceed to re-establish the connection between UE 1 120 and the UE 2 124 and re-initiate the communications session, as part of communications session re-establishment. In step 670 the core network 102, e.g., the automatic reconnection function 104 of the core network 102, generates and sends call/session establishment signaling 671 to base station 2 118 to initiate re-establishment of the communication session with UE 2 124, as a communications session endpoint (e.g., via a wireless connection between BS 2 118 and UE 2 124, in response to the received re-initiation request 668. In step 673 core network 102, e.g., the automatic reconnection function 104 of the core network 102, generates and sends call/session establishment signaling 674 to base station 1 116, to initiate re-establishment of the communications session with UE 1 120, as a communication endpoint (e.g., via a wireless connection between BS 1 116 and UE 1 120) in response to the received re-initiation request 668.

In step 672, base station 2 118 receives call/session establishment signaling 671, and in response in step 676 base station 2 118 generates and sends connection request 677 to UE 2 124. In step 678 UE 2 124 receives the connection request 677. In step 675, base station 1 116 receives call/session establishment signaling 674, and in response in step 679 base station 1 116 generates and sends connection request 680 to UE 1 120. In step 681 UE 1 129 receives the connection request 680.

In steps 682 and 683 UE 1 120 and UE 2 124 are operated to re-establish the connection between UE 1 120 and UE 1 24 for a communications session. In step 685 communications session traffic signals (e.g., voice, data, and/or video) are communicated between UE 1 120 and UE 1 24 via base station 1 116 and base station 2 118 as part of a re-established communications session. In step 686 UE 1 120 is operated to communicate with base station 1 116, e.g., sending and receiving wireless signals 690 including traffic signals over a first wireless connection between base station 1 116 and UE 1 120, as part of the re-established communications session. In step 687 base station 1 116 is operated to communicate with UE 1 120, e.g., receiving and sending wireless signals 690 including traffics signals over a first wireless connection between base station 1 116 and UE 1 120, as part of the re-established communications session. In step 687 base station 1 116 is also operated to communicate with base station 2 118, e.g., sending and receiving signals 690 including traffics signals over a communications path which includes core network 102, e.g., including one or more UPFs, as part of the re-established communications session. In step 688 base station 2 118 is operated to communicate with base station 1 116, e.g., receiving and sending signals 690 including traffics signals over a communications path which includes core network 102 including one or more UPFs, as part of the re-established communications session. In step 688 base station 2 118 is also operated to communicate with UE 2 124, e.g., sending and receiving wireless signals 692 including traffics signals over a second wireless connection between base station 2 118 and UE 2 124, as part of the re-established communications session. In step 689 UE 2 124 is operated to communicate with base station 2 118, e.g., receiving and receiving wireless signals 694 including traffic signals over the second wireless connection between base station 2 118 and UE 2 124, as part of the re-established communications session.

In step 690 UE 1 120, in response to the user 1 deciding to end the communications session, generates and sends user disconnection message 691 to base station 1 116, which, in step 690 receives the message 691 and performs operations to terminate the connection and communications session. Alternatively, in step 693 UE 2 124, in response to user 2 deciding to end the communications session, generates and sends user disconnection message 694 to base station 2 118, which in step 695 receives message 694 and performs operations to terminate the communications session.

In step 696 the system 100 releases resources reserved for supporting the re-established connection and re-established communications session between UE 1 120 and UE 2 124. In step 697 core network 102, e.g., SMF 103 in core network 102, generates and sends a message 698 to base station 1 116 commanding base station 1 116 to release resources for UE 1 116, which had been allocated to supporting the communications session between UE 1 120 and UE 2 124, which has now been terminated. In step 699 base station 1 116 receives message 698 and releases the resources for UE 1 120. In step 6991 core network 102, e.g., SMF 103 in core network 102, generates and sends a message 6992 to base station 2 118 commanding base station 2 118 to release resources for UE 2 118, which had been allocated to supporting the communications session between UE 1 120 and UE 2 124, which has now been terminated. In step 6993 base station 2 118 receives message 6992 and release the resources for UE 2 124.

The example of FIG. 5 shows an exemplary scenario in which a communications session with two endpoint UEs, each with an airlink to a base station. The methods of the present invention are also suitable for embodiments in which there are more than two, e.g., three or more endpoint UEs, each with an airlink connection to a base station, which are participating in a communications session. In some such embodiments, the analytics server 110 evaluates each of the UE to base station airlinks to determine if there is sufficient quality to support re-establishment of the communications session, and for a re-initiation request to be sent, each of the air links (3 or more) needs to satisfy the quality requirements. The methods of the present invention are also suitable for use in a communications session in which only one endpoint device, e.g. one UE has a wireless connection to a base station, and in such a scenario, only the endpoint with the airlink connection needs to satisfy the quality requirement for the analytics server to send the re-initiation request message.

In some embodiments, network performance server (108), which receives (606, 617) network performance information (e.g., measurement report (604), measurement report 616)) from multiple devices (e.g., BS 1 16, BS 1 18) which provide their own measurement information and/or measurement information obtained from UEs (120, 124) (e.g., via UE measurements reports 598, 610) in the communications network (100), sends (626) the measurement information (628) to the analytics server (110) to allow the analytics server (110) to determine when airlinks (146, 150) are of sufficient quality to allow successful communications session re-establishment between the first UE (120) and the second UE (124).

In some embodiments, the operational status of base stations involved in the communications session are checked. Step 644, which involves a check to see if the first or second BSs (BS 1 116 or BS 2 118) are subject to a problem which would prevent the communication session from proceeding even if there is sufficient airlink quality, is an optional step performed in some but not necessarily all embodiments as part of determining (619) if the communications session can be re-established.

In some embodiments, the step of determining (619) when communications session re-establishment is possible includes determining (6191) when connection re-establishment is possible based on base station to UE air link quality.

In some embodiments, said step of determining (619) when communications session re-establishment is possible includes: determining (6191) when connection re-establishment is possible based on base station to UE air link quality (e.g., air link quality of a first airlink between UE 1 120 and BS1 116 and air link quality of a second airlink between UE 2 124 and BS2 118); and checking (645) base station operational status (e.g., determine if there is a problem with BS1 (116) operation and/or an outage at BS1 (116) (e.g., due to fault or due to maintenance) which would prevent session re-establishment, and determine if there is a problem with BS2 (118) operation and/or an outage at BS2 (118) (e.g., due to fault or due to maintenance) which would prevent session re-establishment).

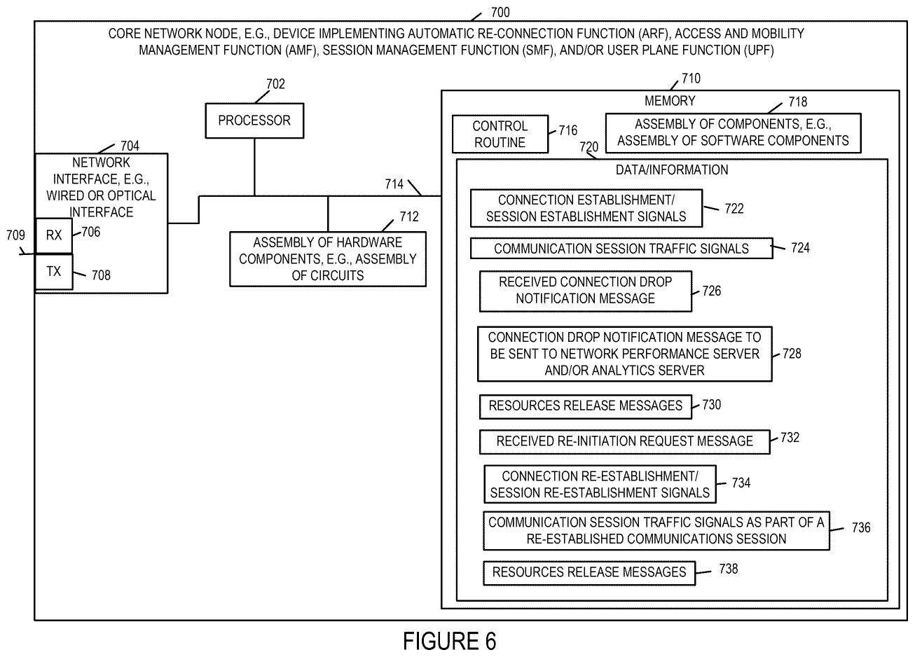

FIG. 6 is a drawing of an exemplary core network node 700, e.g., a device implementing an automatic re-connection function (ARF), an access and mobility management (AMF), a session management function (SMF), and/or a user plane function (UPF), in accordance with an exemplary embodiment. Core network node 700 is, e.g., a device implementing core network 102, AMF 101, SMF 103, ARF 104, and/or UPF 105 of FIG. 1 and/or FIG. 5.

Core network node 700 includes a processor 702, e.g., a CPU, a network interface 704, memory 710, and assembly of hardware components 712, e.g., an assembly of circuits, coupled together via bus 714 over which the various elements may interchange data and information.

Network interface 704, e.g., a wired or optical interface, includes a receiver (RX) 706, a transmitter (TX) 708 and connector 709 coupled together. Memory 710 includes a control routine 716, an assembly of components 718, e.g., an assembly of software components, and data information 720.

Control routine 716 includes instructions, which when executed by processor 702, control the core network node 700 to implement basic operational functions, e.g., read memory, write to memory, control an interface, load a program, subroutine, or app, etc. Assembly of components 718, e.g., an assembly of software components, e.g., routines, subroutines, applications, etc., includes, e.g., code, e.g., machine executable instructions, which when executed by processor 702, controls the core network node 700 to implement steps of a method, e.g., steps of a method which are performed by core network 102, AMF 101, SMF 103, ARF 104, and/or UPF 105 of system 100 of FIG. 1 and/or of signaling diagram 500 FIG. 5.

Data/information 720 includes connection establishment/session establishment signals 722, communications session traffic signals 724, a received connection drop notification message 726, e.g., received from a base station, a connection drop notification message 728 to be sent to a network performance server and/or an analytics server, resource release messages 730, a received re-initiation request message 732 from an analytics server, connection reestablishment/session re-establishment signals 734, communications session traffic signals 736 which are being communicated via the core network as part of a re-established communications session, and resource release messages 738.

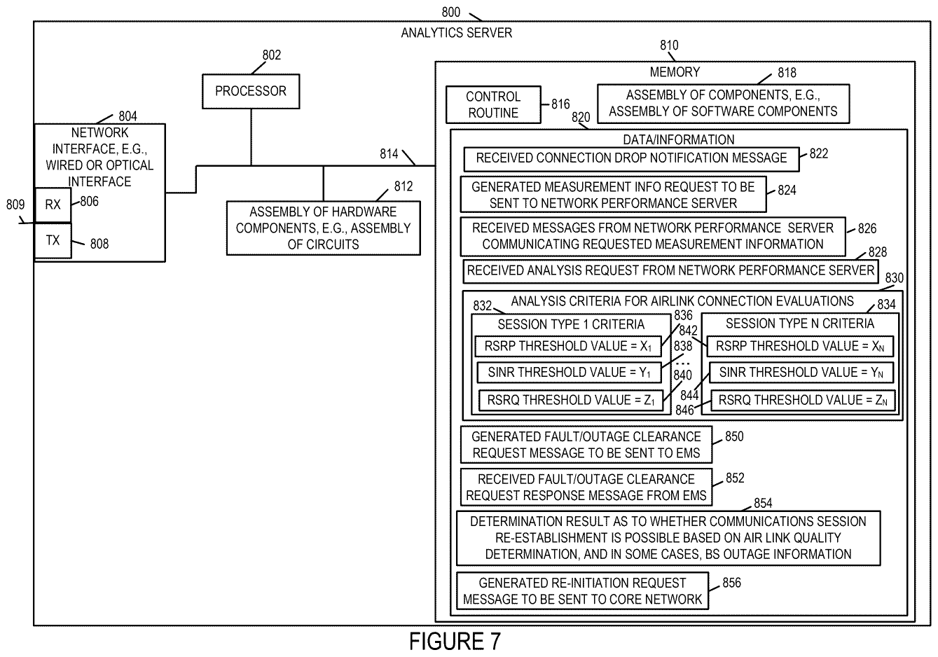

FIG. 7 is a drawing of an exemplary analytics server 800 in accordance with an exemplary embodiment. Analytics server 800 is, e.g., analytics server 110 of FIG. 1 and/or FIG. 5.

Analytics server 800 includes a processor 802, e.g., a CPU, a network interface 804, memory 810, and an assembly of hardware components 812, e.g., an assembly of circuits, coupled together via bus 814 over which the various elements may interchange data and information.

Network interface 804, e.g., a wired or optical interface, includes a receiver (RX) 806, a transmitter (TX) 808 and connector 809 coupled together. Memory 810 includes a control routine 816, an assembly of components 818, e.g., an assembly of software components, and data information 820.

Control routine 816 includes instructions which when executed by processor 802 control the analytics server 800 to implement basic operational functions, e.g., read memory, write to memory, control an interface, load a program, subroutine, or app, etc. Assembly of components 818, e.g., an assembly of software components, e.g., routines, subroutines, applications, etc., includes, e.g., code, e.g., machine executable instructions, which when executed by processor 802, controls the analytics server 800 to implement steps of a method, e.g., steps of a method which are performed by analytics server 110 of system 100 of FIG. 1 and/or of signaling diagram 500 FIG. 5.

Data/information 820 includes a received connection drop notification message 822, a generated measurement information request message 824 to be sent to a network performance server, received messages 826 from network performance server communicating the requested measurement information, e.g. UE measurement information including, e.g., reference signals received power (RSRP), signal-to-interference plus noise ratio (SINR), reference signal received quality (RSRQ), corresponding to airlink between a UE and a base station, a received analysis request 828 from a network performance server, and analysis criteria 834 for airlink connection evaluations. Analysis criteria for airlink connection evaluations 830 includes sets of analysis criteria corresponding to different types of communications sessions (communications session type 1 criteria 832, . . . , communications session type N criteria 834). Communications session type 1 criteria 832 includes a RSRP threshold value=X1 836, a SINR threshold value=Y1 838 and a RSRQ threshold value=Z1 840. Communications session type N criteria 834 includes a RSRP threshold value =XN 842, a SINR threshold value=YN 844 and a RSRQ threshold value=ZN 846. Different types of communications sessions may, and sometimes do, have different criteria values for one or more of all of: RSRP threshold, SINR threshold, and RSRQ threshold. In some embodiments, X1 is different than XN. In some embodiments, Y1 is different than YN. In some embodiments, Z1 is different thanZN. Data/information 820 further includes a generated fault/outage clearance request message 850 to be sent to an EMS, e.g., indicating a set of base stations, e.g., base station 1 and base station 2, a received fault/outage clearance request response message 852 from an EMS, and a determination result 854 as to whether communications session re-establishment is possible based on air link quality determinations, and in some cases, further based on base station outage information, and a generated re-initiation request response message 856 to be sent to base stations to trigger re-initiation of the communications session.

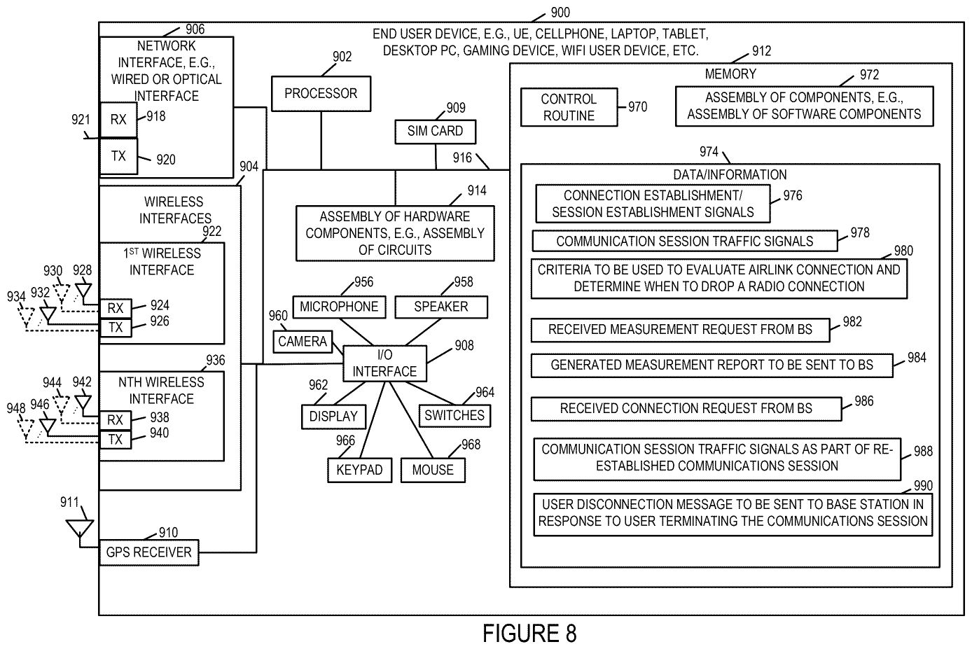

FIG. 8 is drawing of an exemplary end user device 900, e.g., a user equipment (UE), cellphone, laptop, tablet, desktop PC, gaming device, WiFi user device, etc., in accordance with an exemplary embodiment. Exemplary end user device 900 is, e.g., UE 1 120 or UE 2 124 of system 100 of FIG. 1 and/or FIG. 5.

End user device 900 includes a processor 902, e.g., a CPU, wireless interfaces 904, a network interface 906, an I/O interface 908, a SIM card 909, a GPS receiver 910, memory 912, and assembly of hardware components 914, e.g., an assembly of circuits, coupled together via bus 916 over which the various elements may interchange data and information.

Wireless interfaces 904 includes a plurality of wireless interfaces (1st wireless interface 922, . . . , Nth wireless interface 936). Different wireless interfaces may correspond to different frequencies, different communications bands, different technologies and/or different communications protocols. 1st wireless interface 922 includes wireless receiver 924 coupled to one or more receive antennas (928, . . . , 930) via which the end user device 900 receives wireless signals, e.g., from a base station. 1st wireless interface 922 includes wireless transmitter 926 coupled to one or more transmit antennas (932, . . . , 934) via which the end user device 900 transmits wireless signals, e.g., to a base station. Nth wireless interface 936 includes wireless receiver 938 coupled to one or more receive antennas (942, . . . , 944) via which the end user device 900 receives wireless signals. Nth wireless interface 936 includes wireless transmitter 940 coupled to one or more transmit antennas (946, . . . , 946) via which the end user device 900 transmits wireless signals.

Network interface 906, e.g., a wired or optical interface, includes receiver 918, transmitter 920 and connector 921 coupled together. Network interface 906 provides a wired or optical connection interface, which may be used by end user device 900, when stationary and when located at a location in which a wired or optical connection, e.g., cable or fiber link connection, is available.

GPS receiver 910 is coupled to GPS antenna 911, via which GPS receiver 910 receives GPS signals. Based on the received GPS signals, GPS receiver 910 determines end user device 900 position, e.g., latitude, longitude and latitude, time, and velocity information.

End user device 900 further includes a plurality of I/O devices (microphone 956, speaker 958, camera 960, display 962, switches 964, keypad 966 and mouse 968) coupled to I/O interface 908, via which the various I/O devices may communicate with each other and/or external devices, receive input from a user of end user device 900 and/or output data/information to a user of end user device 900.

Memory 912 includes a control routine 970, an assembly of components 972, e.g., an assembly of software components, and data/information 974. Control routine 970 includes instructions which when executed by processor 902 control the end user device 900 to implement basic operational functions, e.g., read memory, write to memory, control an interface, load a program, subroutine, or app, etc. Assembly of components 972, e.g., an assembly of software components, e.g., routines, subroutines, applications, etc., includes, e.g., code, e.g., machine executable instructions, which when executed by processor 902, controls the end user device 900 to implement steps of a method, e.g., steps of a method which are performed by any of the UEs (UE 1 120, UE 2 124, UE n1 122, UE n2) of system 100 of FIG. 1 and/or of signaling diagram 500 FIG. 5.

Data/information 974 includes connection establishment/session establishment signals 976, communications session traffic signals 978, criteria 980, e.g., a RSRP threshold, a SINR threshold, and a RSRQ threshold, to be used to evaluate an airlink connection with a base station, corresponding to a communications session, and determine when to drop the radio connection, a received measurement request 982 from a base station, a generated measurement report 984 to be sent to the base station, a received connection request 986 from a base station, requesting re-establishment of the radio connection as part of re-establishing a communications session, communications session traffic signals 988 being communicated as part of a re-established communications session, an a user disconnection message 990 to be sent to a base station in response to a user of the UE terminating the communications session.

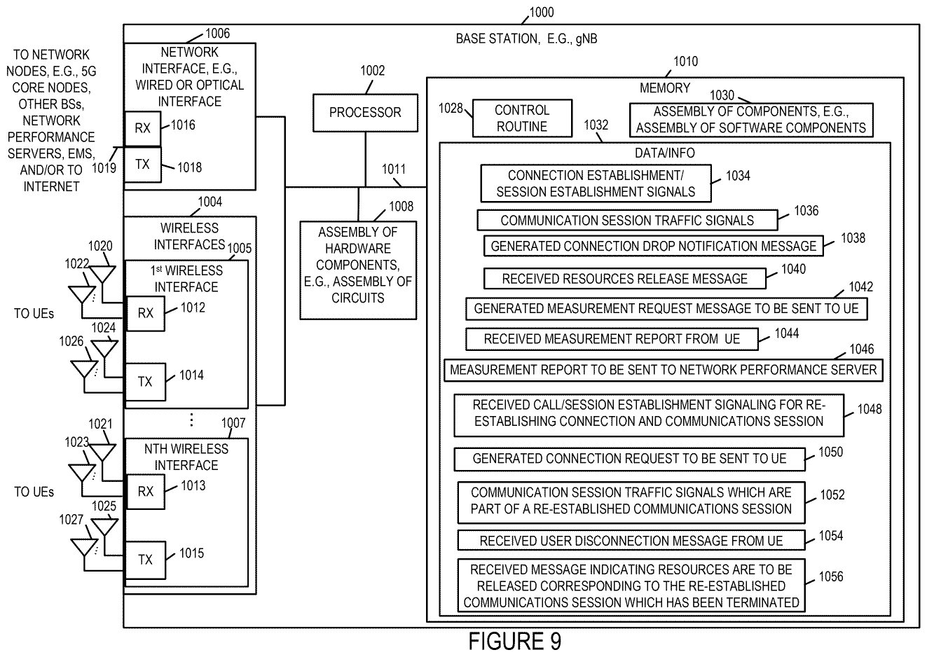

FIG. 9 is drawing of an exemplary base station 1000, e.g., a gNB, in accordance with an exemplary embodiment. Exemplary base station 1000 is, e.g., base station 1 (BS 1 ) 116 or base station 2 (BS 2 ) 118 of system 100 of FIG. 1 and/or FIG. 5.

Base station 1000 includes a processor 1002, e.g., a CPU, wireless interfaces 1004, a network interface 1006, an assembly of hardware components 1008, e.g., an assembly of circuits, and memory 1010 coupled together via bus 1011 over which the various elements may interchange data and information.

Wireless interfaces 1004 includes a plurality of wireless interfaces (1st wireless interface 1005, . . . , Nth wireless interface 1007). Different wireless interfaces may correspond to different frequencies, different communications bands, different technologies and/or different communications protocols. 1st wireless interface 1005 includes wireless receiver 1012 coupled to one or more receive antennas (1020, . . . , 1022) via which the base station 1000 receives wireless signals, e.g., from UEs. 1st wireless interface 1005 includes wireless transmitter 1014 coupled to one or more transmit antennas (1024, . . . , 1026) via which the base station 1000 transmits wireless signals, e.g., to UEs. Nth wireless interface 1007 includes wireless receiver 1013 coupled to one or more receive antennas (1021, . . . , 1023) via which the base station 100 receives wireless signals, e.g., from UEs. Nth wireless interface 1007 includes wireless transmitter 1015 coupled to one or more transmit antennas (1025, . . . , 1027) via which the base station 1000 transmits wireless signals, e.g., to UEs.

Network interface 1006, e.g., a wired or optical interface, includes receiver 1016, transmitter 1018 and connector 1019 coupled together. Network interface 1006 couples base station 1000 to network nodes, e.g., 5G core nodes, other base stations, network performance servers, analytics serves, EMS devices, and/or the Internet.

Memory 1010 includes a control routine 1028, an assembly of components 1030, e.g., an assembly of software components, and data information 1032. Control routine 1028 includes instructions which when executed by processor 1002 control the base station 1000 to implement basic operational functions, e.g., read memory, write to memory, control an interface, load a program, subroutine, or app, etc. Assembly of components 1030, e.g., an assembly of software components, e.g., routines, subroutines, applications, etc., includes, e.g., code, e.g., machine executable instructions, which when executed by processor 1002, controls the base station 1000 to implement steps of a method, e.g., steps of a method which are performed by base station 1 116 or base station 2 118 of system 100 of FIG. 1 and/or of signaling diagram 500 FIG. 5.

Data/information 1032 includes connection establishment/session establishment signals 1034, communications session traffic signals 1036, a generated connection drop notification message 1038, a received resources release message 1040, a generated measurement request message 1042 to be sent to a UE, a received measurement report 1044 from a UE in response to the request, a measurement report 1046 to be sent to a network performance server, which may, and sometimes does, includes aggregated and/or processed information from multiple reports from a UE, received call/session establishment signals 1048 for re-establishing a connection and communications session, a generated connection request message 1050 to be sent to a UE, requesting the UE to re-connect with the base station as part of a session re-establishment procedure, communications session traffic signals 1052, which are part of a re-established communications session, a received user disconnection message from a UE 1 054, an a received message 1056 indicating resources are to be released correspond to the re-established communications session which has been terminated.

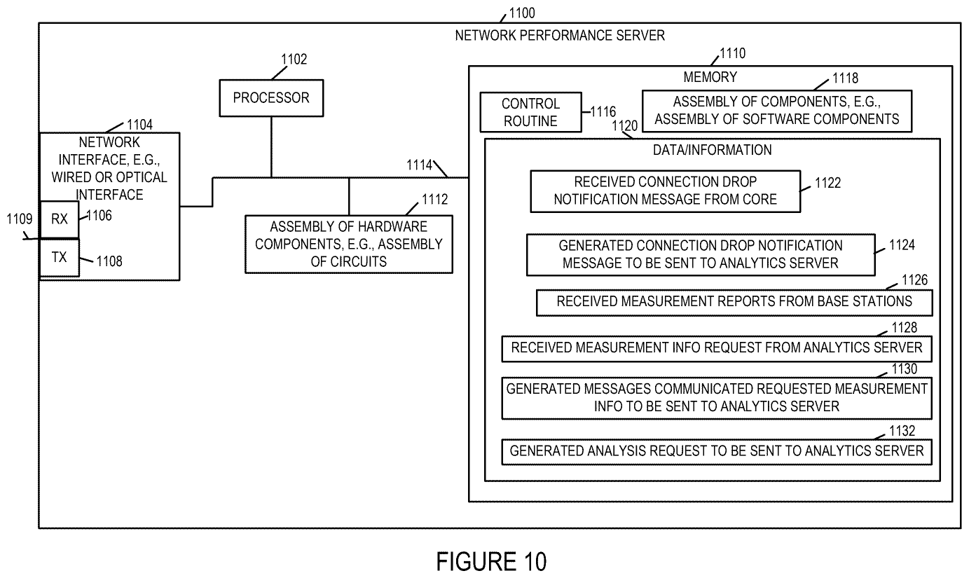

FIG. 10 is a drawing of an exemplary network performance server 1100 in accordance with an exemplary embodiment. Network performance server 1100 is, e.g., network performance server 108 of FIG. 1 and/or FIG. 5.

Network performance server 1100 includes a processor 1102, e.g., a CPU, a network interface 1104, memory 1110, and assembly of hardware components 1112, e.g., an assembly of circuits, coupled together via bus 1114 over which the various elements may interchange data and information.

Network interface 1104, e.g., a wired or optical interface, includes a receiver (RX) 1106, a transmitter (TX) 1108 and connector 1109 coupled together. Memory 1110 includes a control routine 1116, an assembly of components 1118, e.g., an assembly of software components, and data information 1120. Control routine 1116 includes instructions which when executed by processor 1102 control the network performance server 1100 to implement basic operational functions, e.g., read memory, write to memory, control an interface, load a program, subroutine, or app, etc. Assembly of components 1118, e.g., an assembly of software components, e.g., routines, subroutines, applications, etc., includes, e.g., code, e.g., machine executable instructions, which when executed by processor 1102, controls the network performance server 1100 to implement steps of a method, e.g., steps of a method which are performed by network performance 108 of system 100 of FIG. 1 and/or of signaling diagram 500 FIG. 5.

Data/information 1120 includes a received connection drop notification message 1122 from a network core, e.g., an ARF of a network core, a generated connection drop notification message 1124 to be sent to an analytics server, e.g., a forwarded copy of received message 1122, received measurements reports 1126 from base stations, a received measurement information request 1128 from an analytics server, generated messages 1130 communicating requested measurement information, said generated messages to be sent to the analytics server, an a generated analysis request 1132 to be sent to the analytics server. In some embodiments, the analysis request includes information identifying: a first UE and first base station, which correspond to a first airlink, a second UE and a second base station which correspond to a second airlink, information identifying an end to end connection in which the first and second UEs are endpoints, a communications session, and the type and/or classification of the communications session, e.g., with regard to traffic being communicated, e.g., voice, video, browsing, best effort, guaranteed bit rate with a first level, guaranteed bit rate with a second level, low latency low loss scalable throughput (L4S), etc.

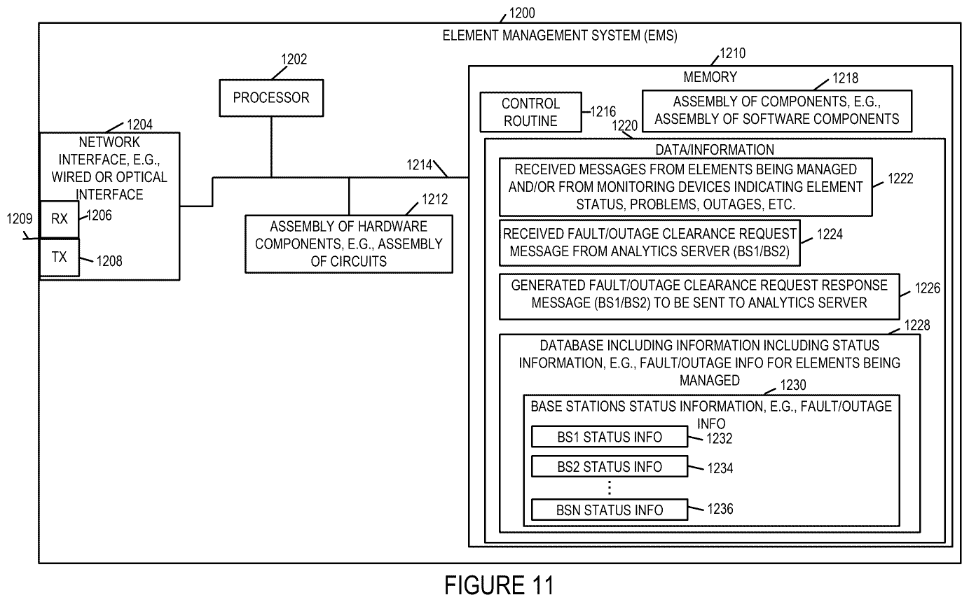

FIG. 11 is a drawing of an exemplary element management system (EMS) 1200 in accordance with an exemplary embodiment. EMS 1200 is, e.g., EMS 106 of FIG. 1 and/or FIG. 5.

EMS 1200 includes a processor 1202, e.g., a CPU, a network interface 1204, memory 1210, and assembly of hardware components 1212, e.g., an assembly of circuits, coupled together via bus 1214 over which the various elements may interchange data and information.

Network interface 1204, e.g., a wired or optical interface, includes a receiver (RX) 1206, a transmitter (TX) 1208 and connector 1209 coupled together. Memory 1210 includes a control routine 1216, an assembly of components 1218, e.g., an assembly of software components, and data information 1220. Control routine 1216 includes instructions which when executed by processor 1202 control the EMS 1200 to implement basic operational functions, e.g., read memory, write to memory, control an interface, load a program, subroutine, or app, etc. Assembly of components 1218, e.g., an assembly of software components, e.g., routines, subroutines, applications, etc., includes, e.g., code, e.g., machine executable instructions, which when executed by processor 1202, controls the EMS 1200 to implement steps of a method, e.g., steps of a method which are performed by EMS 106 of system 100 of FIG. 1 and/or of signaling diagram 500 FIG. 5.

Data/information 1220 includes received messages 1222 from elements being managed and/or from monitoring devices indicating element status, problems, outages, service (maintenance) intervals, etc., a received fault/outage clearance request message 1224 from an analytics server, e.g. requesting the EMS 1200 to check on a set of base stations (base station 1, base station 2) to determine if there are any outages, problems, failures, or other reasons, e.g., maintenance intervals, which could prevent re-establishment of a communications session which utilizes those base stations (BS1, BS2) as part of the communications path for traffic data signals. Data/information 1220 further includes a database 1228 including status information, e.g., fault/outage information, for elements being managed by EMS 1200. Database 1228 includes base station information 1230, e.g., fault/outage information corresponding to a plurality of base stations being managed. Base station status information 1230 includes BS1 status information, BS2 status information, . . . , BSN status information 1236.

### Numbered Exemplary Method Embodiments

Method Embodiment 1. A communication method, the method comprising: receiving (566), at a analytics server (110), notification of a connection drop corresponding to a communications session (e.g., a voice, data or video session) between a first user equipment (UE) (120) and a second UE (124) (e.g., receive a connection drop notification message from the core network (102) and/or a network performance server (108) informing the analytics server (110) of a connection drop, e.g., a non-UE initiated connection drop, of a connection corresponding to a communications session in which at least a first UE (120) and a second UE (124) are connection end points, said connection notification message in some embodiments including information, e.g., device identifiers, corresponding to the first UE (120) and second UE (122) and information identifying a first base station (BS) (116) being used as a network point of attachment by the first UE (120) and a second BS (118) being used as a network point of attachment by the second UE (124)); determining (619) (e.g., at the analytics server (110)) when communications session re-establishment is possible based on base station to UE air link quality (e.g., quality of a first airlink between the first BS (116) and first UE (120) and quality of a second airlink between the second BS (118) and second UE (124)), said step of determining (619) when communications session re-establishment is possible including determining (666) that communications session re-establishment is possible (e.g., when at least airlink conditions allow for communications session re-establishment); and in response to determining (666) that communications session re-establishment is possible, sending (e.g., from analytics server 110) a communications session re-initiation request (668) (e.g., to the core network 102) to trigger communications session re-initiation, as part of communications session re-establishment between the first UE and the second UE (e.g., a re-initiation request including information identifying UE 1 (120) and UE 2 (124) and/or including an identifier identifying the said communications session which was dropped is sent to the core network (102) and processed by an automatic reconnection function (104) included therein. Depending on the embodiment the automatic reconnection function (104) can be implemented as a separate function or, optionally, as a function within the session management function (SMF) (103)).

Method Embodiment 1A. The method of Method Embodiment 1, further comprising, prior to receiving (566), at the analytics server (110), the notification of the connection drop corresponding to a communications session, operating the first BS (116) to detect (548) a drop of a connection (e.g., a wireless connection between the first BS (116) and first UE (129) that was being used to support the communications session) with the first UE (120); and in response to detecting (548) the drop of the connection between the first BS (116) and first UE (120), operating the first BS (116) to send (550) a connection drop notification message (552) to the core network (102) (e.g., to the Automatic Reconnection Function (ARF) (104) in the core network (102)).

Method Embodiment 1B. The method of Method Embodiment 1A, further comprising: determining (555) at the core network (102) that said connection drop indicated in the connection drop message (552) was received without the user of the first UE (120) or user of the second UE (124) initiating termination of the communications session (e.g., as would have been indicated by the core network (102) receiving communications session related termination signaling relating to the communications session prior to receiving the connection drop notification message (552) corresponding to the dropped communications session).

Method Embodiment 2. The method of Method Embodiment 1, wherein determining (619) when session re-establishment is possible includes: checking (639) airlink quality measurement information to determine if a first airlink between the first BS (116) and the first UE (120) is of sufficient quality to support the communications session; and checking (640) airlink quality measurement information to determine if a second airlink between the second BS (118) and the second UE (124) is of sufficient quality to support the communications session.

Method Embodiment 3. The method of Method Embodiment 2, wherein determining (619) when communications session re-establishment is possible further includes: determining (641) that both the first and second airlinks are of sufficient quality to support the communications session (e.g., checks determine that the quality metric or metrics associated with each of the first and second airlinks equal or exceed a corresponding quality threshold used to determine if the communications session can be supported).

Method Embodiment 3A. The method of Method Embodiment 3, further comprising: receiving (630) measurement information (628), at the analytics server (110), including airlink quality information corresponding to i) the airlink (146) between the first base station (116) and first UE (120), ii) the airlink (150) between the second base station (118) and second UE (124) or iii) both the airlink (146) between the first base station (116) and first UE (120), and the airlink (150) between the second base station (118) and the second UE (124).

Method Embodiment 3B. The method of Method Embodiment 3A, wherein the measurement information (628) includes airlink measurements made by at least one of the first UE (120) and the second UE (124).

Method Embodiment 3C. The method of Method Embodiment 3B, wherein a network performance server (108), which receives (606, 617) network performance information (e.g., measurement report (604), measurement report 616)) from multiple devices (e.g., BS 1 16, BS 1 18) which provide their own measurement information and/or measurement information obtained from UEs (120, 124) (e.g., via UE measurements reports 598, 610) in the communications network (100), sends (626) the measurement information (628) to the analytics server (110) to allow the analytics server (110) to determine when airlinks (146, 150) are of sufficient quality to allow successful communications session re-establishment between the first UE (120) and the second UE (124).

Method embodiment 3D. The method of Method Embodiment 1, wherein determining (619) if the communications session can be re-established includes checking (645) BS operational status, (which in some embodiments involves a check to see if the first or second BSs are subject to a problem which would prevent the communication session from proceeding even if there is sufficient airlink quality. This is an optional step performed in some but not necessarily all embodiments).

Method Embodiment 4. The method of Method Embodiment 3, wherein determining (619) when communications session re-establishment is possible further includes: checking (6621) if there is a problem at the first base station (116) which would prevent the communications session from being re-established; and checking (6622) if there is a problem at the second base station (118) which would prevent the communications session from being re-established.

Method Embodiment 4A. The method of Method Embodiment 4, wherein determining (619) when communications session re-establishment is possible further includes: determining (641) based on said checks that there is not a problem at either of said first and second base stations that would prevent the communications session from being re-established.

Method Embodiment 5. The communications method of Method Embodiment 3, further comprising: operating the core network (102) (e.g., the ARF (104) which is part of the core network (102)) to send (670) session establishment signaling (671) to the second base station (118) to initiate re-establishment of the communications session with the second UE (124) as a communications session endpoint (e.g., via a wireless connection between the second BS (118) and second UE (124)); and operating the core network (102) (e.g., the ARF (104) which is part of the core network (102)) to send (673) session establishment signaling (674) to the first base station (116) to initiate re-establishment of the communications session with the first UE (120) as a communications session endpoint (e.g., via a wireless connection between the first BS (116) and first UE (120)).

Method Embodiment 6. The communications method of Method Embodiment 5, further comprising: communicating (685) communications session traffic (e.g., voice, data and/or video) between the first and second UEs (120, 124) via the first and second base stations (116, 118) as part of a re-established communication session.

Method Embodiment 7. The communications method of Method Embodiment 6, further comprising: releasing (696) communications resources reserved for the re-established communications session in response to a disconnect signal (691 or 694) from the first or second UEs (120, 124).

Method Embodiment 8. The method of Method Embodiment 1, wherein said step of determining (619) when communications session re-establishment is possible includes determining (6191) when connection re-establishment is possible based on base station to UE air link quality.

Method Embodiment 9. The method of Method Embodiment 1, wherein said step of determining (619) when communications session re-establishment is possible includes: determining (6191) when connection re-establishment is possible based on base station to UE air link quality (e.g., air link quality of a first airlink between UE 1 120 and BS1 116 and air link quality of a second airlink between UE 2 124 and BS2 118); and checking (645) base station operational status (e.g., determine if there is a problem with BS1 (116) operation and/or an outage at BS1 (116) (e.g., due to fault or due to maintenance) which would prevent session re-establishment, and determine if there is a problem with BS2 (118) operation and/or an outage at BS2 (118) (e.g., due to fault or due to maintenance) which would prevent session re-establishment).

### Numbered Exemplary System Embodiments

System Embodiment 1. A communication system (100), the system comprising: an analytics server (110) including a first processor (802) configured to operate the analytics server to: receive (566), at the analytics server (110), notification of a connection drop corresponding to a communications session (e.g., a voice, data or video session) between a first user equipment (UE) (120) and a second UE (124) (e.g., receive a connection drop notification message from the core network (102) and/or a network performance server (108) informing the analytics server (110) of a connection drop, e.g., a non-UE initiated connection drop, of a connection corresponding to a communications session in which at least a first UE (120) and a second UE (124) are connection end points, said connection notification message in some embodiments including information, e.g., device identifiers, corresponding to the first UE (120) and second UE (122) and information identifying a first base station (BS) (116) being used as a network point of attachment by the first UE (120) and a second BS (118) being used as a network point of attachment by the second UE (124)); determine (619) (e.g., at the analytics server (110)) when communications session re-establishment is possible based on base station to UE air link quality (e.g., quality of a first airlink between the first BS (116) and first UE (120) and quality of a second airlink between the second BS (118) and second UE (124)), said step of determining (619) when communications session re-establishment is possible including determining (666) that communications session re-establishment is possible (e.g., when at least airlink conditions allow for communications session re-establishment); and in response to determining (666) that communications session re-establishment is possible, send (e.g., from analytics server 110) a communications session re-initiation request (668) (e.g., to the core network 102) to trigger communications session re-initiation, as part of communications session re-establishment between the first UE and the second UE (e.g., a re-initiation request including information identifying UE 1 (120) and UE 2 (124) and/or including an identifier identifying the said communications session which was dropped is sent to the core network (102) and processed by an automatic reconnection function (104) included therein. Depending on the embodiment the automatic reconnection function (104) can be implemented as a separate function or, optionally, as a function within the session management function (SMF) (103)).

System Embodiment 1A. The communications system (100) of System Embodiment 1, further comprising: a first base station (BS) (116) including a second processor (1002) configured to: operate the first BS (116) to detect (548), prior to the analytics server (110) receiving the notification of the connection drop corresponding to a communications session, a drop of a connection (e.g., a wireless connection between the first BS (116) and first UE (129) that was being used to support the communications session) with the first UE (120); and in response to detecting (548) the drop of the connection between the first BS (116) and first UE (120), operate the first BS (116) to send (550) a connection drop notification message (552) to the core network (102) (e.g., to the Automatic Reconnection Function (ARF) (104) in the core network (102)).

System Embodiment 1B. The communications system (100) of System Embodiment 1A, further comprising: a core network (102) including a third processor (702) configured to operate the core network to: determine (555), at the core network (102), that said connection drop indicated in the connection drop message (552) was received without the user of the first UE (120) or user of the second UE (124) initiating termination of the communications session (e.g., as would have been indicated by the core network (102) receiving communications session related termination signaling relating to the communications session prior to receiving the connection drop notification message (552) corresponding to the dropped communications session).

System Embodiment 2. The communications system (100) of System Embodiment 1, wherein first processor (802) is configured to: operate the analytics server (110) to: check (639) airlink quality measurement information to determine if a first airlink between the first BS (116) and the first UE (120) is of sufficient quality to support the communications session; and check (640) airlink quality measurement information to determine if a second airlink between the second BS (118) and the second UE (124) is of sufficient quality to support the communications session, as part of being configured to determine (619) when session re-establishment is possible.

System Embodiment 3. The communications system (100) of System Embodiment 2, wherein said first processor (802) is configured to: determine (641) that both the first and second airlinks are of sufficient quality to support the communications session (e.g., checks determine that the quality metric or metrics associated with each of the first and second airlinks equal or exceed a corresponding quality threshold used to determine if the communications session can be supported), as part of being configured to determine (619) when communications session re-establishment is possible.

System Embodiment 3A. The communications system (100) of System Embodiment 3, wherein said first processor (802) is further configured to operate the analytics server (110) to: receive (630) measurement information (628), at the analytics server (110), including airlink quality information corresponding to i) the airlink (146) between the first base station (116) and first UE (120), ii) the airlink (150) between the second base station (118) and second UE (124) or iii) both the airlink (146) between the first base station (116) and first UE (120), and the airlink (150) between the second base station (118) and the second UE (124).

System Embodiment 3B. The communications system (100) of System Embodiment 3A, wherein the measurement information (628) includes airlink measurements made by at least one of the first UE (120) and the second UE (124).

System Embodiment 3C. The communications system (100) of System Embodiment 3B, further comprising: a network performance server (108) including a second processor (1102) configured to: operate the network performance server (108), to receive (606, 617) network performance information (e.g., measurement report (604), measurement report 616)) from multiple devices (e.g., BS 1 16, BS 1 18) which provide their own measurement information and/or measurement information obtained from UEs (120, 124) (e.g., via UE measurements reports 598, 610) in the communications network (100); and operate the network performance server (108) to send (626) the measurement information (628) to the analytics server (110) to allow the analytics server (110) to determine when airlinks (146, 150) are of sufficient quality to allow successful communications session re-establishment between the first UE (120) and the second UE (124).

System Embodiment 4. The communications system (100) of System Embodiment 3, wherein said first processor (802) is configured to operate the analytics server (110) to: check (6621) if there is a problem at the first base station (116) which would prevent the communications session from being re-established; and check (6622) if there is a problem at the second base station (118) which would prevent the communications session from being re-established, as part of being configured to determine (619) when communications session re-establishment is possible.

System Embodiment 4A. The communications system of System Embodiment 4, wherein said first processor (802) is configured to: determine (641) based on said checks that there is not a problem at either of said first and second base stations that would prevent the communications session from being re-established, as part of being configured to determine (619) when communications session re-establishment is possible.

System Embodiment 5. The communications system (100) of System Embodiment 3, further comprising: said core network (102) including a second processor (602) configured to: operate the core network (102) (e.g., the ARF (104) which is part of the core network (102)) to send (670) session establishment signaling (671) to the second base station (118) to initiate re-establishment of the communications session with the second UE (124) as a communications session endpoint (e.g., via a wireless connection between the second BS (118) and second UE (124)); and operate the core network (102) (e.g., the ARF (104) which is part of the core network (102)) to send (673) session establishment signaling (674) to the first base station (116) to initiate re-establishment of the communications session with the first UE (120) as a communications session endpoint (e.g., via a wireless connection between the first BS (116) and first UE (120)).

System Embodiment 6. The communications system (100) of System Embodiment 5, wherein said second processor (602) is further configured to operate the core network (102) to control the communications system (100) to: communicate (685) communications session traffic (e.g., voice, data and/or video) between the first and second UEs (120, 124) via the first and second base stations (116, 118) as part of a re-established communication session.

System Embodiment 7. The communications system (100) of System Embodiment 6, wherein said second processor (602) is further configured to operate the core network to: release (696) communications resources reserved for the re-established communications session in response to a disconnect signal (691 or 694) from the first or second UEs (120, 124).

System Embodiment 8. The communications system (100) of System Embodiment 1, wherein first processor (802) is configured to operate the analytics server (110) to: determine (6191) when connection re-establishment is possible based on base station to UE air link quality, as part of being configured to operate the analytics server (110) to determine (619) when communications session re-establishment is possible.

System Embodiment 9. The communications system (100) of System Embodiment 1, wherein said first processor (802) is configured to operate the analytics server to: determine (6191) when connection re-establishment is possible based on base station to UE air link quality (e.g., air link quality of a first airlink between UE 1 120 and BS1 116 and air link quality of a second airlink between UE 2 124 and BS2 118); and check (645) base station operational status (e.g., determine if there is a problem with BS1 (116) operation and/or an outage at BS1 (116) (e.g., due to fault or due to maintenance) which would prevent session re-establishment, and determine if there is a problem with BS2 (118) operation and/or an outage at BS2 (118) (e.g., due to fault or due to maintenance) which would prevent session re-establishment), as part of being configured to operate the analytics server (110) to determine (619) when communications session re-establishment is possible.

### Numbered Exemplary Non-transitory Computer

### Readable Medium Embodiments

Non-Transitory Computer Readable Medium Embodiment 1. A non-transitory computer readable medium (810) including machine executable instructions, which when executed by a processor (802) of an analytics server (110), cause the analytics server (110) to perform the steps of: receiving (566), at the analytics server (110), notification of a connection drop corresponding to a communications session (e.g., a voice, data or video session) between a first user equipment (UE) (120) and a second UE (124) (e.g., receive a connection drop notification message from the core network (102) and/or a network performance server (108) informing the analytics server (110) of a connection drop, e.g., a non-UE initiated connection drop, of a connection corresponding to a communications session in which at least a first UE (120) and a second UE (124) are connection end points, said connection notification message in some embodiments including information, e.g., device identifiers, corresponding to the first UE (120) and second UE (122) and information identifying a first base station (BS) (116) being used as a network point of attachment by the first UE (120) and a second BS (118) being used as a network point of attachment by the second UE (124)); determining (619) (e.g., at the analytics server (110)) when communications session re-establishment is possible based on base station to UE air link quality (e.g., quality of a first airlink between the first BS (116) and first UE (120) and quality of a second airlink between the second BS (118) and second UE (124)), said step of determining (619) when communications session re-establishment is possible including determining (666) that communications session re-establishment is possible (e.g., when at least airlink conditions allow for communications session re-establishment); and in response to determining (666) that communications session re-establishment is possible, sending (e.g., from analytics server 110) a communications session re-initiation request (668) (e.g., to the core network 102) to trigger communications session re-initiation, as part of communications session re-establishment between the first UE (120) and the second UE (120) (e.g., a re-initiation request including information identifying UE 1 (120) and UE 2 (124) and/or including an identifier identifying the said communications session which was dropped is sent to the core network (102) and processed by an automatic reconnection function (104) included therein. Depending on the embodiment the automatic reconnection function (104) can be implemented as a separate function or, optionally, as a function within the session management function (SMF) (103)).

Various aspects and/or features of some embodiments of the present invention are described below. Methods and apparatus for reconnecting users and re-establishing a communications session, corresponding to a dropped connection and dropped communications session, based on information obtained from ad hoc requests of measurements are described. In some embodiments, after a connection is dropped for the first time due to a radio network failure, base stations request measurements from end user devices (e.g., a first end user device corresponding to user A and a second end user device corresponding to user B), which were participating in the dropped communications session. The end user devices perform measurements and send the measurement reports to the base stations, which communicate, e.g., via a network performance server, the end user measurement information to an analytics server. The analytics server evaluates the received measurements to determine if acceptable radio conditions are being experienced by each of the end user devices. The measurements, reporting, and evaluating are performed, repetitively on a timely basis. When the analysis determines that each of the end user devices are experiencing acceptable radio conditions (e.g., acceptable RSRP, SINR and RSRQ), the analytics server will send a re-initiation request to the network core. In response, the network core is operated to reestablish the connection and communications session, and traffic signals are communicated between the end user devices over the re-established end-to-end connection and re-established communications session.

In some embodiments, the end users, e.g. both end user A and end user B, are notified of connection drop due to network quality; however, there will be a re-attempt to reestablish the connection and communications session at a specific instance, when the channel quality has been determined to become better, e.g., of sufficient quality to support the communications session.

In some embodiments, once the session, e.g., call, has been dropped due to poor network quality being experienced by one or more (e.g., both) user devices, the base station(s) will place those end user devices into a monitoring set. User devices, which are in the monitoring set, perform measurements and report instantaneous coverage and quality of network. Once the analytics server determines that each of the end user devices, e.g. the first user device corresponding to user A and the second user device corresponding to user B, are in good covers and the level of interference being experienced is acceptable, the analytics server will notify the core, e.g., via a re-initiate request message. The core will notify the base stations, which will send connection requests to the end user devices, and the end user devices will connect to the core. The end-to-end connection will be re-established, and the communications session will be re-established. This approach will improve the user experience while maintaining service quality.

In some embodiments, the method of the present invention can be, and sometimes is, applied when communications sessions, e.g., calls, are abruptly terminated due to any reason. In some embodiments, the exemplary method can be, and sometimes is, implemented as a feature, allowing a user to select the choice as to whether to perform session re-establishment (e.g., automatic call back) or not. This feature can be advantageous for call centers, which often need such an automatic call back, since customers are frequently waiting in line (in a queue for a live person) for 30 minutes or more, and if a call gets disconnected, it can be difficult to reach out back to the same parties and establish the connection.

Various embodiments are directed to a non-transitory machine readable storage device, e.g., memory, with processor executable instructions stored thereon, which when executed by a processor of an apparatus, e.g., an analytics server, a core network node, network performance server, element management system (EMS), base station, or UE, control the apparatus to implement any one or more of the above described methods or numbered method embodiments.

The techniques of various embodiments may be implemented using software, hardware and/or a combination of software and hardware. Various embodiments are directed to apparatus, e.g., analytics servers, core network nodes, network performance server, element management systems (EMSs), base stations, UEs, access points (AP), e.g., WiFi APs, supporting SCS and/or MSCS, stations (STAs), e.g., WiFi STAs, supporting SCS and/or MSCS, user equipment devices, wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements. Various embodiments are also directed to methods, e.g., method of controlling and/or operating analytics servers, core network nodes, network performance servers, element management systems (EMSs), base stations, UEs, access points (APs), e.g., WiFi APs, supporting SCS and/or MSCS, stations (STAs), e.g., WiFi STAs, supporting SCS and/or MSCS, user equipment devices, wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements. Various embodiments are also directed to machine, e.g., computer, readable medium, e.g., ROM, RAM, CDs, hard discs, etc., which include machine readable instructions for controlling a machine to implement one or more steps of a method. The computer readable medium is, e.g., non-transitory computer readable medium.

It is understood that the specific order or hierarchy of steps in the processes and methods disclosed is an example of exemplary approaches. Based upon design preferences, it is understood that the specific order or hierarchy of steps in the processes and methods may be rearranged while remaining within the scope of the present disclosure. The accompanying method claims present elements of the various steps in a sample order and are not meant to be limited to the specific order or hierarchy presented. In some embodiments, one or more processors are used to carry out one or more steps of each of the described methods.

In various embodiments each of the steps or elements of a method are implemented using one or more processors. In some embodiments, each of elements or steps are implemented using hardware circuitry.

In some embodiments a buffer is implemented in the form of a queue. Thus, the terms buffers and queues are sometimes used to refer to the same thing.

In various embodiments devices, e.g., analytics servers, core network nodes, network performance servers, element management systems (EMSs), base stations, e.g. base stations which use 3GPP or non- 3GPP technologies, UEs, access points (AP), e.g., WiFi APs, supporting SCS and/or MSCS, stations (STAs), e.g., WiFi STAs, supporting SCS and/or MSCS, user equipment devices, wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements described herein are implemented using one or more components to perform the steps corresponding to one or more methods, for example, provisioning APs, STAs, user equipment devices, provisioning AP devices, provisioning AAA servers, provisioning orchestration servers, generating messages, message reception, message transmission, signal processing, sending, comparing, determining and/or transmission steps. Thus, in some embodiments various features are implemented using components or, in some embodiments, logic such as for example logic circuits. Such components may be implemented using software, hardware or a combination of software and hardware. Many of the above described methods or method steps can be implemented using machine executable instructions, such as software, included in a machine readable medium such as a memory device, e.g., RAM, floppy disk, etc. to control a machine, e.g., general purpose computer with or without additional hardware, to implement all or portions of the above described methods, e.g., in one or more devices, servers, nodes and/or elements. Accordingly, among other things, various embodiments are directed to a machine-readable medium, e.g., a non-transitory computer readable medium, including machine executable instructions for causing a machine, e.g., processor and associated hardware, to perform one or more of the steps of the above-described method(s). Some embodiments are directed to a device, e.g., a controller, including a processor configured to implement one, multiple or all of the steps of one or more methods of the invention.

In some embodiments, the processor or processors, e.g., CPUs, of one or more devices, e.g., analytics servers, core network nodes, network performance servers, element management systems (EMSs), base stations, UEs, access points (AP), e.g., WiFi APs, supporting SCS and/or MSCS, stations (STAs), e.g., WiFi STAs, supporting SCS and/or MSCS, user equipment devices, wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements, are configured to perform the steps of the methods described as being performed by the user equipment devices, wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements. The configuration of the processor may be achieved by using one or more components, e.g., software components, to control processor configuration and/or by including hardware in the processor, e.g., hardware components, to perform the recited steps and/or control processor configuration. Accordingly, some but not all embodiments are directed to a device, e.g., analytics servers, core network nodes, network performance servers, element management systems (EMSs), base stations, UEs, access point (AP), e.g., WiFi AP, supporting SCS and/or MSCS, station (STA), e.g., WiFi STA, supporting SCS and/or MSCS, user equipment devices, wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements, with a processor which includes a component corresponding to each of the steps of the various described methods performed by the device in which the processor is included. In some but not all embodiments a device, e.g., analytics server, core network node, network performance server, element management system (EMS), base station, UE, access points (AP), e.g., WiFi AP, supporting SCS and/or MSCS, stations (STA), e.g., WiFi STA, supporting SCS and/or MSCS, user equipment devices, wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements, includes a controller corresponding to each of the steps of the various described methods performed by the device in which the processor is included. The components may be implemented using software and/or hardware.

Some embodiments are directed to a computer program product comprising a computer-readable medium, e.g., a non-transitory computer-readable medium, comprising code for causing a computer, or multiple computers, to implement various functions, steps, acts and/or operations, e.g., one or more steps described above. Depending on the embodiment, the computer program product can, and sometimes does, include different code for each step to be performed. Thus, the computer program product may, and sometimes does, include code for each individual step of a method, e.g., a method of controlling a device, e.g., analytics server, core network node, network performance server, element management system (EMS), base station, UE, an access point (AP), e.g., WiFi AP, supporting SCS and/or MSCS, a stations (STA), e.g., a WiFi STA, supporting SCS and/or MSCS, user equipment devices, wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements. The code may be in the form of machine, e.g., computer, executable instructions stored on a computer-readable medium, e.g., a non-transitory computer-readable medium, such as a RAM (Random Access Memory), ROM (Read Only Memory) or other type of storage device. In addition to being directed to a computer program product, some embodiments are directed to a processor configured to implement one or more of the various functions, steps, acts and/or operations of one or more methods described above. Accordingly, some embodiments are directed to a processor, e.g., CPU, configured to implement some or all of the steps of the methods described herein. The processor may be for use in, e.g., a communications device such an analytics server, core network node, network performance server, element management system (EMS), base station, UE, access point (AP), e.g., a WiFi AP, supporting SCS and/or MSCS, a station (STA), e.g., WiFi STA, supporting SCS and/or MSCS, a user equipment device, wireless device, mobile device, smartphone, subscriber device, desktop computer, printer, IPTV, laptop, tablets, network edge device, Access Point, wireless router, switch, WLAN controller, orchestration server, orchestrator, Gateway, AAA server, server, node and/or element or other device described in the present application.

Numerous additional variations on the methods and apparatus of the various embodiments described above will be apparent to those skilled in the art in view of the above description. Such variations are to be considered within the scope. Numerous additional embodiments, within the scope of the present invention, will be apparent to those of ordinary skill in the art in view of the above description and the claims which follow. Such variations are to be considered within the scope of the invention.

What is claimed is:

1. A communication method, the method comprising:
receiving, at an analytics server, notification of a connection drop corresponding to a communications session between a first user equipment (UE) and a second UE;
determining when communications session re-establishment is possible based on base station to UE air link quality; and
in response to determining that communications session re-establishment is possible, sending a communications session re-initiation request to trigger communications session re-initiation, as part of communications session re-establishment between the first UE and the second UE.

2. The method of claim 1, further comprising:
prior to receiving, at the analytics server, the notification of the connection drop corresponding to a communications session, operating the first BS to detect a drop of a connection with the first UE; and
in response to detecting the drop of the connection between the first BS and first UE, operating the first BS to send a connection drop notification message to the core network.

3. The method of claim 1,
wherein determining when session re-establishment is possible includes:
checking airlink quality measurement information to determine if a first airlink between the first BS and the first UE is of sufficient quality to support the communications session; and
checking airlink quality measurement information to determine if a second airlink between the second BS and the second UE is of sufficient quality to support the communications session.

4. The method of claim 3, wherein determining when communications session re-establishment is possible further includes:
determining that both the first and second airlinks are of sufficient quality to support the communications session.

5. The method of claim 4, wherein determining when communications session re-establishment is possible further includes:
checking if there is a problem at the first base station which would prevent the communications session from being re-established; and
checking if there is a problem at the second base station which would prevent the communications session from being re-established.

6. The communications method of claim 4, further comprising:
operating the core network to send session establishment signaling to the second base station to initiate re-establishment of the communications session with the second UE being a communications session endpoint; and
operating the core network to send session establishment signaling to the first base station to initiate re-establishment of the communications session with the first UE as a communications session endpoint.

7. The communications method of claim 6, further comprising:
communicating communications session traffic between the first and second UEs via the first and second base stations as part of a re-established communication session.

8. The communications method of claim 7, further comprising:
releasing communications resources reserved for the re-established communications session in response to a disconnect signal from the first or second UEs.

9. The method of claim 1, wherein said step of determining when communications session re-establishment is possible includes determining when connection re-establishment is possible based on base station to UE air link quality.

10. The method of claim 1, wherein said step of determining when communications session re-establishment is possible includes:
determining when connection re-establishment is possible based on base station to UE air link quality; and
checking base station operational status.

11. A communication system, the system comprising:
an analytics server including a first processor configured to operate the analytics server to:
receive, at the analytics server, notification of a connection drop corresponding to a communications session between a first user equipment (UE) and a second UE;
determine when communications session re-establishment is possible based on base station to UE air link quality; and
in response to determining that communications session re-establishment is possible, send a communications session re-initiation request to trigger communications session re-initiation, as part of communications session re-establishment between the first UE and the second UE.

12. The communications system of claim 11, further comprising:
a first base station (BS) including a second processor configured to:
operate the first BS to detect, prior to the analytics server receiving the notification of the connection drop corresponding to a communications session, a drop of a connection with the first UE; and
in response to detecting the drop of the connection between the first BS and first UE, operate the first BS to send a connection drop notification message to the core network.

13. The communications system of claim 12, wherein the first processor is configured to:
operate the analytics server to:
check airlink quality measurement information to determine if a first airlink between the first BS and the first UE is of sufficient quality to support the communications session; and
check airlink quality measurement information to determine if a second airlink between the second BS and the second UE is of sufficient quality to support the communications session,
as part of being configured to determine when session re-establishment is possible.

14. The communications system of claim 13, wherein said first processor is configured to:
determine that both the first and second airlinks are of sufficient quality to support the communications session, as part of being configured to determine when communications session re-establishment is possible.

15. The communications system of claim 14, wherein said first processor is configured to operate the analytics server to:
check if there is a problem at the first base station which would prevent the communications session from being re-established; and
check if there is a problem at the second base station which would prevent the communications session from being re-established,
as part of being configured to determine when communications session re-establishment is possible.

16. The communications system of claim 4, further comprising:
said core network including a second processor configured to:
operate the core network to send session establishment signaling to the second base station to initiate re-establishment of the communications session with the second UE as a communications session endpoint; and
operate the core network to send session establishment signaling to the first base station to initiate re-establishment of the communications session with the first UE being a communications session endpoint.

17. The communications system of claim 16, wherein said second processor is further configured to operate the core network to control the communications system to:
communicate communications session traffic between the first and second UEs via the first and second base stations as part of a re-established communication session.

18. The communications system of claim 17, wherein said second processor is further configured to operate the core network to:
release communications resources reserved for the re-established communications session in response to a disconnect signal from the first or second UEs.

19. The communications system of claim 11, wherein first processor is configured to operate the analytics server to:
determine when connection re-establishment is possible based on base station to UE air link quality, as part of being configured to operate the analytics server to determine when communications session re-establishment is possible.

20. A non-transitory computer readable medium including machine executable instructions, which when executed by a processor of an analytics server, cause the analytics server to perform the steps of:
receiving, at the analytics server, notification of a connection drop corresponding to a communications session between a first user equipment (UE) and a second UE;
determining when communications session re-establishment is possible based on base station to UE air link quality, said step of determining when communications session re-establishment is possible including determining that communications session re-establishment is possible; and
in response to determining that communications session re-establishment is possible, sending a communications session re-initiation request to trigger communications session re-initiation, as part of communications session re-establishment between the first UE and the second UE.
